(19) United States
(12) Patent Application Publication
(10) Pub. No.: US 2026/0150956 A1
(43) Pub. Date: Jun. 4, 2026

(54) CONTROL METHOD AND CONTROL DEVICE OF ORAL CARE DEVICE

(71) Applicant: GUANGZHOU STARS PULSE CO.,LTD., GUANGZHOU (CN)

(72) Inventors: ZHICHENG ZHANG, GUANGZHOU (CN); JING LI, GUANGZHOU (CN); JIANQUN CHEN, GUANGZHOU (CN); HAOZHE TIAN, GUANGZHOU (CN); JUN PAN, GUANGZHOU (CN)

(21) Appl. No.: 19/464,819

(22) Filed: Jan. 30, 2026

Related U.S. Application Data
(63) Continuation-in-part of application No. PCT/CN2024/098400, filed on Jun. 11, 2024.

(30) Foreign Application Priority Data
Jul. 31, 2023 (CN) 202310958192.6
Jul. 31, 2023 (CN) 202322042249.6
Sep. 27, 2023 (CN) 202311269633.8

(51) Int. Cl. A46B 13/02; A46B 15/00; A61C 17/22; A61C 17/34

(52) U.S. Cl. CPC A46B 13/023; A46B 15/0006; A46B 15/0008; A46B 15/0012; A46B 15/004; A46B 15/0046; A61C 17/221; A61C 17/3481

(57) ABSTRACT

An oral care device and a control method thereof are provided. The oral care device includes a motor. The control method includes steps of obtaining target oral care information and determining a target driving signal based on the current oral care information, and controlling a motor of the oral care device to vibrate based on the target driving signal, so that the motor drives a care component of the oral care device to vibrate to generate sound prompting information. The target oral care information includes current oral care information of the oral care device. The sound prompting information is matched with the current oral care information. When a current oral care position or an attribute of the current oral care position changes, a loudness/volume of sound prompting vibrations generated by the motor driving the care component changes.

### TECHNICAL FIELD

The present disclosure relates to a field of care technology, and in particular to a control method of an oral care device and the oral care device.

### BACKGROUND

As intelligence of toothbrushes continues to improve, visualization of brushing information is also constantly improving. In related art, users generally obtain interactive information about the toothbrushes when brushing teeth through an application (APP) on external terminals or small screens or speakers disposed on the toothbrushes.

However, a method of displaying the interactive information of the toothbrushes through the APP on the external terminals requires to pre-establish a connection between the toothbrushes and the external terminals, making a display method thereof too cumbersome. A method of displaying the interactive information of the toothbrushes through the small screens on the toothbrushes causes information lag. In addition, a method of obtaining the interactive information of the toothbrushes when brushing the teeth through the small screens or the speakers disposed on the toothbrushes undoubtedly increases the manufacturing cost of the toothbrushes.

### SUMMARY

The present disclosure provides a control method of an oral care device, a control device of the oral care device, the oral care device, and a storage medium.

The present disclosure utilizes regular vibrations of a motor of the oral care device to generate a sound that matches current oral care information to output interactive information when using the oral care device, which improves a synchronization of prompting information of the oral care device and does not need to equip additional devices such as speakers and screens. When the motor vibrates, the motor drives a care component to vibrate. When the care component contacts the teeth, the sound is transmitted to ears of a user in a form of bone conduction, avoiding a problem of configuring a speaker hole on a handle of the oral care device to affect sealing performance of the handle and increase manufacturing cost of the oral care device.

In a first aspect, the present disclosure provides a control method of an oral care device. The oral care device comprises a motor. The control method comprises steps of obtaining target oral care information and determining a target driving signal based on the current oral care information, and controlling a motor of the oral care device to vibrate based on the target driving signal, so that the motor drives a care component of the oral care device to vibrate to generate sound prompting information. The target oral care information comprises current oral care information of the oral care device. The sound prompting information is matched with the current oral care information, where the current oral care position or the current oral care position changes, and the loudness of the incisor sound generated by the care component driven by the motor changes.

In a second aspect, the present disclosure provides an oral care device. The oral care device comprises a processor and a memory. The memory is configured to store computer programs. The computer programs are configured to be loaded by the processor to execute steps of the control method in the first aspect of the present disclosure.

In the present disclosure, the current oral care information of the oral care device is obtained, the target driving signal is determined based on the current oral care information, the motor of the oral care device is controlled to vibrate based on the target driving signal, so that the motor drives the care component of the oral care device to vibrate to generate the sound prompting information matched with the current oral care information. The present disclosure utilizes regular vibrations of the motor of the oral care device to generate the sound that matches the current oral care information to output interactive information when using the oral care device, which improves the synchronization of the prompting information of the oral care device and does not need to equip additional devices such as speakers and screens. When the motor vibrates, the motor drives the care component to vibrate. When the care component contacts the teeth, the sound is transmitted to the ears of the user in the form of bone conduction, avoiding the problem of configuring the speaker hole on the handle of the oral care device to affect the sealing performance of the handle and increase the manufacturing cost of the oral care device.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of an oral care device according to one embodiment of the present disclosure.

FIG. 2 is a flow chart of a control method of the oral care device according to one embodiment of the present disclosure.

FIG. 3 is a schematic diagram of a predetermined condition according to one embodiment of the present disclosure.

FIG. 4 is a schematic diagram of an implementation process of the control method of the oral care device according to one embodiment of the present disclosure.

FIG. 5 is a schematic diagram of an architecture of a control system of the oral care device according to one embodiment of the present disclosure.

FIG. 6 is a schematic diagram of another implementation process of the control method of the oral care device according to one embodiment of the present disclosure.

FIG. 7 is a schematic diagram of another implementation process of the control method of the oral care device according to one embodiment of the present disclosure.

FIG. 8 is a schematic diagram of another implementation process of the control method of the oral care device according to one embodiment of the present disclosure.

FIG. 9 is a flow chart of the control method of the oral care device according to another embodiment of the present disclosure.

FIG. 10 is a flow chart of the control method of the oral care device according to another embodiment of the present disclosure.

FIG. 11 is a schematic diagram of an implementation process of the control method of the oral care device according to another embodiment of the present disclosure.

FIG. 12 is a schematic diagram of another implementation process of the control method of the oral care device according to another embodiment of the present disclosure.

FIG. 13 is a schematic diagram of another implementation process of the control method of the oral care device according to another embodiment of the present disclosure.

FIG. 14 is a schematic diagram of another implementation process of the control method of the oral care device according to another embodiment of the present disclosure.

FIG. 15 is a schematic diagram of another implementation process of the control method of the oral care device according to another embodiment of the present disclosure.

FIG. 16 is a schematic diagram of another implementation process of the control method of the oral care device according to another embodiment of the present disclosure.

FIG. 17 is a schematic diagram of a process of determining a target driving signal according to one embodiment of the present disclosure.

FIG. 18 is a flow chart of the control method of the oral care device according to another embodiment of the present disclosure.

FIG. 19 is a structural schematic diagram of the oral care device according to one embodiment of the present disclosure.

FIG. 20 is a block diagram of the oral care device according to another embodiment of the present disclosure.

FIG. 21 is a block diagram of the oral care device according to another embodiment of the present disclosure.

FIG. 22 is a block diagram of the oral care device according to another embodiment of the present disclosure.

FIG. 23 is a block diagram of the oral care device according to another embodiment of the present disclosure.

FIG. 24 is a block diagram of the oral care device according to another embodiment of the present disclosure.

FIG. 25 is a block diagram of the oral care device according to another embodiment of the present disclosure.

FIG. 26 is a block diagram of the oral care device according to another embodiment of the present disclosure.

FIG. 27 is a block diagram of the oral care device according to another embodiment of the present disclosure.

FIG. 28 is a structural schematic diagram of a control device of the oral care device according to one embodiment of the present disclosure.

FIG. 29 is a structural schematic diagram of a control device of the oral care device according to another embodiment of the present disclosure.

FIG. 30 is a structural schematic diagram of the oral care device according to another embodiment of the present disclosure.

### DETAILED DESCRIPTION

The following clearly describes the technical solutions in the present disclosure with reference to the accompanying drawings.

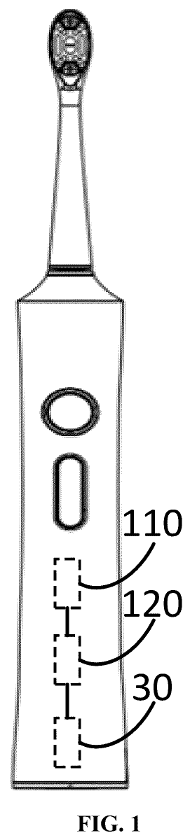

FIG. 1 is a structural schematic diagram of an oral care device according to one embodiment of the present disclosure. As shown in FIG. 1, the oral care device 1900 comprises a control unit 110, a motor driving piece 120, and a motor 30.

The control unit 110 may be a microcontroller unit (MCU). The MCU is also known as a single-chip microcomputer or a single chip. The MCU appropriately reduces a frequency and specifications of a central process unit (CPU), and integrates peripheral interfaces such as memory, counter, USB, A/D conversion, universal asynchronous receiver/transmitter (UART), programmable logic controller (PLC), data memory access (DMA), and even liquid crystal display (LCD) drive circuits on a single chip to form a chip-level computer, which performs different combination controls for different application scenarios.

In one embodiment, in an oral care process, the control unit 110 of the oral care device obtains target oral care information, determines a target audio driving signal and a target cleaning driving signal based on the target oral care information, and outputs the target audio driving signal and the target cleaning driving signal to the motor 30 according to the target audio driving signal and the target cleaning driving signal, so that the target audio driving signal and the target cleaning driving signal are output in non-overlapping time periods according to a predetermined rule, and the motor 30 is controlled to vibrate based on the target audio driving signal and the target cleaning driving signal. The target audio driving signal and the target cleaning driving signal are output in non-overlapping time periods, that is, the target audio driving signal is not output when the target audio driving signal is output and the target audio driving signal is not output when the target cleaning driving signal is output. Therefore, it is ensured that a cleaning vibration mode of the motor 30 is stable, and generated sound interference is less and purer.

The motor driving piece 120 may be a motor driving piece chip. The motor 30 may be, but is not limited to, a sonic motor. The motor driving piece 120 is configured to drive the motor 30 to vibrate, and then vibrations of the motor 30 drives the care component (such as, but not limited to, a brush head, etc.) connected to the motor 30 to play audio in a bone conduction manner, and/or the vibrations of the motor 30 drive the care component connected to the motor 30 to realize oral care, etc.

It is understood that the oral care device may be, for example, but is not limited to, an electric toothbrush, an oral irrigator, etc. The oral care device may also be, but not limited to, equipped with one or more indicator lights, one or more buttons, a speaker, etc.

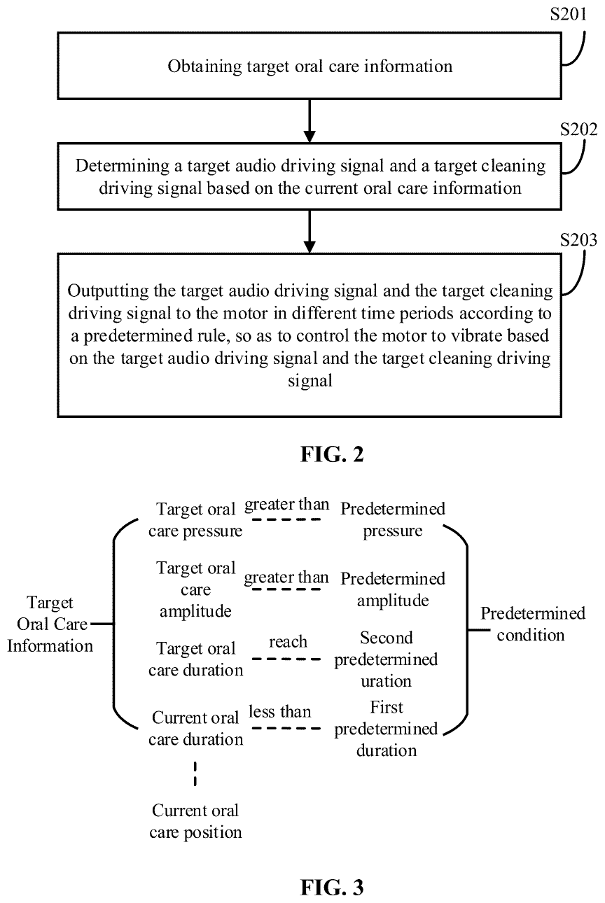

In conjunction with FIG. 1, a control method of the oral care device according to one embodiment of the present disclosure is introduced. FIG. 2 is a flow chart of a control method of the oral care device according to one embodiment of the present disclosure. As shown in FIG. 2, the control method comprises steps S201-S203.

The step S201 comprises obtaining target oral care information.

In one embodiment, during the oral care process, the oral care device is enabled to obtain the target oral care information through a detection element. The target oral care information comprises at least one of a current target oral care pressure, a target oral care amplitude, a target oral care position, and a target oral care duration of the oral care device through a detection element. The oral care device is further configured to directly determine at least one of a current target oral care mode, a target oral care status, etc., of the target oral care information. The embodiments of the present disclosure are not limited thereto.

The step S202 comprises determining a target audio driving signal and a target cleaning driving signal based on the current oral care information.

In one embodiment, after obtaining the target oral care information, a target audio file is obtained based on the target oral care information, and the target audio file is decoded to obtain the target audio driving signal. Meanwhile, the target cleaning driving signal is determined based on the target oral care information. In the embodiment of the present disclosure, the target audio driving signal and the target cleaning driving signal are directly determined according to the target oral care information, so that the oral care device performs corresponding oral care and audio playback according to the target oral care information, thereby ensuring both an oral care effect and an oral care experience.

It is understood that in order to save storage space of the oral care device and reduce a demand for the storage space of the oral care device, after obtaining the target oral care information, the oral care device is capable of sending the target oral care information to a terminal connected to the oral care device, and receive the target audio file returned by the terminal based on the target oral care information. In order to ensure audio output efficiency of the oral care device, different audio files are pre-stored in the oral care device. After the oral care device obtains the target oral care information, the oral care device is capable of directly extracting the target audio file from the audio files pre-stored in the oral care device based on the target oral care information.

It is understood that the oral care device is able to, but is not limited to, pre-store correspondences respectively between oral care information, audio driving signals, and cleaning driving signals. After obtaining the oral care information, the target audio driving signal and the target cleaning driving signal corresponding to the target oral care information are directly retrieved from the correspondences.

The step S203 comprises outputting the target audio driving signal and the target cleaning driving signal to the motor in different time periods according to a predetermined rule, so as to control the motor to vibrate based on the target audio driving signal and the target cleaning driving signal.

In one embodiment, an output time period corresponding to the target audio driving signal does not overlap an output time period corresponding to the target cleaning driving signal, so that it is ensured that the oral care device does not output the target cleaning driving signal when outputting the target audio driving signal, and does not output the target audio driving signal when outputting the target cleaning driving signal.

In the embodiment of the present disclosure, after obtaining the target oral care information, the target audio driving signal and the target cleaning driving signal are determined based on the target oral care information, and the target audio driving signal and the target cleaning driving signal are output to the motor in non-overlapping time periods according to the predetermined rule to control the motor to vibrate based on the target audio driving signal and the target cleaning driving signal. That is, the oral care device realizes audio playback at a relatively low cost through bone conduction without providing an additional speaker. In addition, the target audio driving signal and the target cleaning driving signal are output to the motor in the non-overlapping time periods, that is, the target cleaning driving signal is not output when the target audio driving signal is output, and the target audio driving signal is not output when the target cleaning driving signal is output. Therefore, it is ensured that the target audio driving signal does not affect the vibrations of the motor driven by the target cleaning driving signal, making a cleaning vibration mode of the motor stable. Moreover, it is ensured that the target cleaning driving signal does not affect audio vibrations of the motor driven by the target audio driving signal, making the sound generated by the motor less disturbed and purer.

The step S203 of outputting the target audio driving signal and the target cleaning driving signal to the motor in different time periods according to the predetermined rule comprises alternately outputting the target audio driving signal and the target cleaning driving signal to the motor. For instance, repeating a circle operation until oral care work of the oral care device is finished and stop outputting the target cleaning driving signal and the output of the target audio driving signal. The circle operation comprises outputting the target cleaning driving signal to the motor for a first duration, suspending an output of the target cleaning driving signal, outputting the target audio driving signal to the motor for a second duration, suspending an output of the target audio driving signal, and outputting the target cleaning driving signal to the motor for the first duration again.

In the embodiment of the present disclosure, when the target audio driving signal and the target cleaning driving signal are alternately output, the target cleaning driving signal is output first and then the target audio driving signal is output, so that the user performs an effective oral care operation first. The effective oral care operation of the user ensures that the target audio driving signal output subsequently realizes effective audio playback by bone conduction. Moreover, in the embodiment of the present disclosure, an effect of oral care reminder is realized by alternately outputting the target audio driving signal and the target cleaning driving signal. For instance, after continuously outputting the target cleaning driving signal for 30 seconds for a current oral care position (target oral care information), the target audio driving signal is continuously output for 3 seconds, thereby reminding the user that an oral care duration of the current oral care position reaches a standard and the user may switch the care component to a next oral care position for oral care.

It is understood that when the target cleaning driving signal and the target audio driving signal are alternately output, the first duration of the target cleaning driving signal is greater than the second duration of the target audio driving signal, so that the user is able to efficiently complete oral care while being able to hear the sound (music or voice). The first duration may be, but not limited to, 30 s, 45 s, etc., and the second duration may be, but not limited to, 3 s, 5 s, etc.

It is understood that when the target cleaning driving signal and the target audio driving signal are alternately output, the first duration of the target cleaning driving signal may be equal to the second duration of the target audio driving signal, so that the user can intuitively experience an effect of a regular alternating output of the audio driving signals and the cleaning driving signals. A swing amplitude of the care component 50 (such as but not limited to the brush head) driven by the motor under the drive of the target audio driving signal is relatively small. By alternately outputting the target cleaning driving signal and the target audio driving signal at equal time periods, an oral care method with alternating large vibration amplitude and small vibration amplitude is formed, which better removes dental plaque and tartar compared to continuous vibrations of the care component 50. Since a time interval between the output of the target audio driving signal and an output of a next audio driving signal is small, and a time interval between the output of the target cleaning driving signal and an output of a next cleaning driving signal is small, the user may have a feeling of listening to the sound while performing the oral care.

It is understood that when alternately outputting the target audio driving signal and the target cleaning driving signal, the target audio driving signal may be output first and then the target cleaning driving signal, which is not limited thereto.

It is understood that a time interval between the non-overlapping time periods of the target audio driving signal and the target cleaning driving signal is not greater than a target duration. The target duration may be but is not limited to 0.5 seconds, 0.2 seconds, etc. In this way, the vibrations output by the motor of the oral care equipment are more continuous, so that the user does not feel an obvious pause during the vibrations of the motor. In particular, when the time interval between the non-overlapping time periods of the target audio driving signal and the target cleaning driving signal is 0, the vibrations of the motor are continuous and smooth without any sense of pause, which ensures the oral care efficiency to a certain extent and saves oral care time of the user.

Optionally, the step S203 of outputting the target audio driving signal and the target cleaning driving signal to the motor in different time periods according to the predetermined rule comprises when the oral care device outputs a cleaning driving signal to the motor, if the target oral care information meets a predetermined condition, suspending an output of the cleaning driving signal, and outputting the target audio driving signal corresponding to the target oral care information to the motor. In the embodiment of the present disclosure, when the target oral care information meets the predetermined condition, the output of the cleaning driving signal is suspended, and only the target audio driving signal corresponding to the target oral care information is output, so as to prompt the user through the target audio driving signal that the current target oral care information meets the predetermined condition. As a result, the user may realize a current oral care situation in time.

Optionally, the step S203 of outputting the target audio driving signal and the target cleaning driving signal to the motor in different time periods according to the predetermined rule comprises: when the oral care device outputs an audio driving signal to the motor, if the target oral care information does not meet the predetermined condition or the audio driving signal is completely output, suspending an output of the audio driving signal, and outputting the target clean driving signal corresponding to the target oral care information to the motor. In the embodiment of the present disclosure, when the target oral care information does not meet the predetermined condition, the output of the audio driving signal is suspended, and only the target cleaning driving signal is output, so as to prompt the user that the target oral care information does not meet the predetermined condition by outputting the target cleaning driving signal. Therefore, the user may realize the current oral care situation in time. At the same time, when the audio driving signal is completely output, the output of the audio driving signal is suspended, and the target cleaning driving signal is output to enable the user to continue the oral care operation.

Furthermore, when the target oral care information is oral care abnormality or oral care being unable to reach the standard, the target oral care information meets the predetermined condition. That is, when the target oral care information is oral care abnormality or oral care being unable to reach the standard, the output of the cleaning driving signal is suspended, and the user is prompted that the current oral care is abnormal or the oral care does not meet the standard by outputting the corresponding target audio driving signal, so that the user is able to adjust the current oral care operation in time.

Optionally, as shown in FIG. 3, the target oral care information comprises the target oral care pressure currently corresponding to the oral care device, and the predetermined condition comprises that the target oral care pressure is greater than the predetermined pressure. That is, when the current target oral care pressure of the oral care device is greater than the predetermined pressure, it indicates that a current oral care pressure of the oral care device is too large to lead to a risk of damaging the oral cavity of the user. Then the user may be prompted that the current oral care pressure is too large by outputting the target audio driving signal, and the user is reminded to reduce the current oral care pressure in time. Optionally, the target oral care information comprises the target oral care amplitude currently corresponding to the oral care device, and the predetermined condition comprises that the target oral care amplitude is greater than the predetermined amplitude. That is, when the current target oral care amplitude of the oral care device is greater than the predetermined amplitude, it indicates that the current target oral care amplitude of the oral care device is too large, the user is prompted that the current oral care amplitude is too large by outputting the target audio driving signal, and the user is reminded to reduce the current oral care amplitude in time. Optionally, the target oral care information comprises the current oral care duration corresponding to the current oral care position of the oral care device, and the predetermined condition comprises that the current oral care duration is less than a first predetermined duration. The first predetermined duration may be 30 seconds(s), 45 s, etc. That is, when the current oral care duration corresponding to the current oral care position of the oral care device does not meet the standard, the user is prompted that the current oral care duration does not meet the standard by outputting the target audio driving signal, so the user is reminded that the current oral care position needs to continue oral care.

Furthermore, when the target oral care information meets the predetermined condition, a first target vibration force corresponding to the target audio driving signal is less than a second target vibration force corresponding to the target cleaning driving signal; and/or a first target swing amplitude corresponding to the target audio driving signal is less than a second target swing amplitude corresponding to the target cleaning driving signal; and/or a first target duty cycle corresponding to the target audio driving signal is less than a second target duty cycle corresponding to the target cleaning driving signal. In this way, while the target audio driving signal being served as a reminder, the vibration force and/or the vibration amplitude of the motor of the oral care device is reduced, and then the vibration force and/or the vibration amplitude of the care component driven by the motor is reduced accordingly, so that the oral care device has a function of overpressure protection.

It is understood that when the target oral care information meets the predetermined condition, the output duration of the target audio driving signal corresponds to or is equal to the duration when the target oral care information is oral care abnormality or oral care being unable to meet the standard. In this way, the user can promptly understand whether the current oral care is still in an abnormal state or whether the current oral care is still not up to standard by whether the target audio driving signal is output.

Optionally, as shown in FIG. 3, the target oral care information comprises the target oral care duration currently corresponding to the oral care device, and the predetermined condition comprises the target oral care time reaching a second predetermined duration, and the second predetermined duration may be, but is not limited to 3 minutes, 2 and a half minutes, etc. In this way, when the target oral care duration reaches the second predetermined duration, the output of the cleaning driving signal is suspended until the user is reminded that the current target oral care duration has been reached by outputting the corresponding target audio driving signal, and the oral care operation stops.

Furthermore, when the target oral care information meets the predetermined condition, a target audio driving amplitude corresponding to the target audio driving signal is reduced, or a target audio driving frequency corresponding to the target audio driving signal is different from a target cleaning driving frequency corresponding to the target cleaning driving signal. Therefore, the oral care device generates a motor audio vibration sound that is significantly different from a cleaning vibration sound, corresponding to the target cleaning driving signal, of the motor when the target oral care information meets the predetermined condition, thereby reminding the user.

Furthermore, when the target oral care information meets the predetermined condition, the output duration of the target audio driving signal is a fixed duration. In this way, the user is reminded of the target oral care information by outputting fixed-duration voice or music to meet the predetermined condition. Alternatively, the output duration of the target audio driving signal corresponds to a target oral care area currently corresponding to the oral care device. In this way, the target audio driving signal is continuously output when caring for the target oral care area. Alternatively, the audio driving signal output corresponding to different oral care areas has different duration, so as to prompt the user which oral care area is currently being cared for.

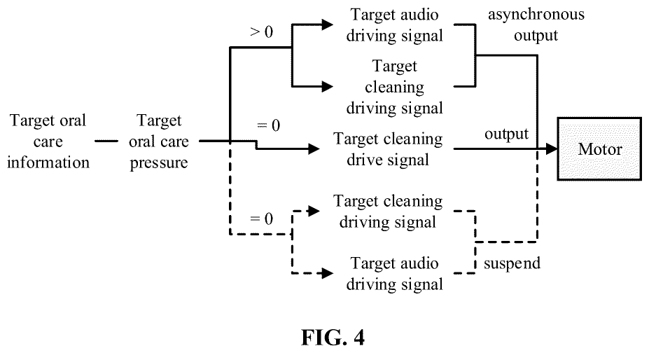

Optionally, as shown in FIG. 4, the target oral care information comprises a target oral care pressure currently corresponding to the oral care device. When the target oral care pressure is greater than 0, it is determined that the care component of the oral care device is placed into the oral cavity of the user, the target audio driving signal and the target cleaning driving signal are output to the motor in different time periods.

That is, the oral care device is enabled to play audio via bone conduction, and the target audio driving signal and the target cleaning driving signal are allowed to be output to the motor in non-overlapping time periods (i.e., asynchronous output), thereby ensuring the effectiveness of the target audio driving signal driving the motor to play audio and ensuring the effectiveness of the target cleaning driving signal driving the motor to perform oral care.

Further, as shown in FIG. 4, when the target oral care pressure is 0, it is determined that the care component of the oral care device is not placed into the oral cavity of the user. That is, the oral care device currently does not meet the prerequisite of being able to play audio in the bone conduction manner. At this time, only the target cleaning driving signal is output to the motor, so the user is reminded by outputting the cleaning driving signal that the oral care device is currently started and subsequent oral care operation is allowed to be started. Alternatively, only the cleaning driving signal is output to remind the user that the oral care device is vibrating or the user has not completed the oral care work, and the user may continue oral care. Therefore, when the care component of the oral care device is not in contact with the oral cavity, a problem of invalid output of the target audio driving signal caused by the user not being able to hear the audio through bone conduction after the target audio driving signal is output is avoided. When the target oral care pressure is 0, it is determined that the care component of the oral care device is not placed in the oral cavity of the user. That is, if the user does not need to perform oral care at present, the output of the target cleaning driving signal and the target audio driving signal is directly suspended to avoid the invalid output of the target cleaning driving signal and the target audio driving signal, which reduces waste of power consumption of the oral care device and enhances the endurance of the oral care device.

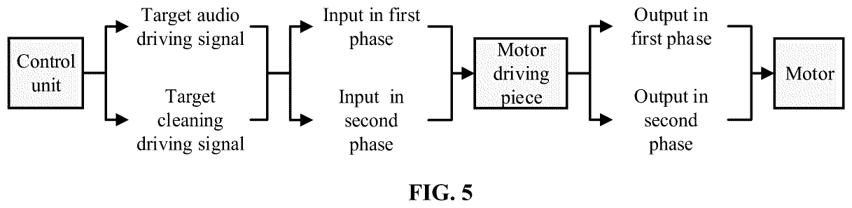

Optionally, as shown in FIG. 5, the oral care device comprises a control unit 110, a motor driving piece 120, and a motor 30. After the control unit 110 determines the target audio driving signal and the target cleaning driving signal based on the target oral care information, the control unit 110 outputs the target audio driving signal and the target cleaning driving signal to the motor 30 in non-overlapping time periods based on the same phase or different phases of the motor driving piece 120. For example, but not limited to, as shown in FIG. 5, the motor driving piece 120 may, but not limited to, have two different phases, such as a first phase and a second phase. The target audio driving signal and the target cleaning driving signal are both input through the first phase or the second phase, or the target audio driving signal is input through the first phase and the target cleaning driving signal is input through the second phase, etc. Similarly, the target audio driving signal and the target cleaning driving signal may be output through the first phase or the second phase of the motor driving piece, or the target audio driving signal is output through the first phase of the motor driving piece and the target cleaning driving signal is output through the second phase of the motor driving piece, etc., and the embodiments of the present disclosure are not limited thereto.

Furthermore, in order to ensure a playback effect corresponding to the target audio driving signal, when the motor driving piece 120 outputs the target audio driving signal to the motor 30, the motor driving piece 120 amplifies the target vibration amplitude corresponding to the target audio driving signal to a predetermined vibration multiple, thereby amplifying an volume corresponding to the target audio driving signal. The predetermined vibration multiple maybe, but is not limited to, 2 times, 3 times, etc.

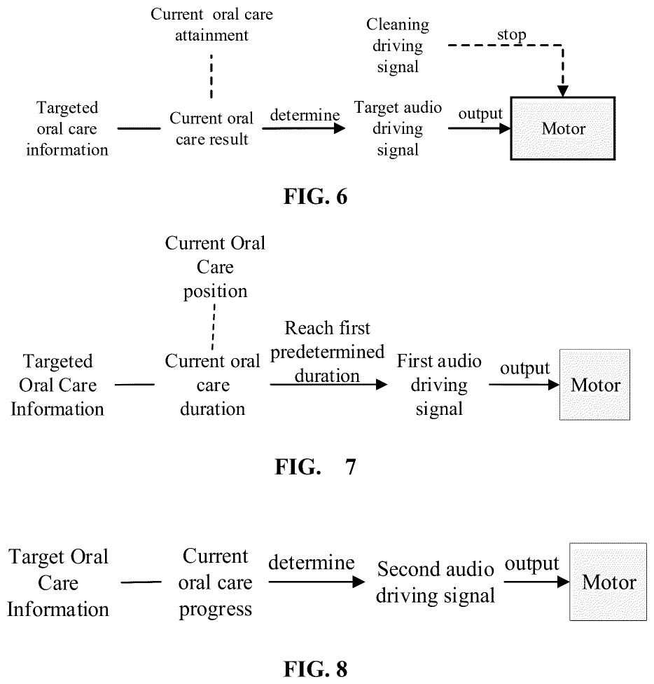

In some optional embodiments, as shown in FIG. 6, the target oral care information comprises a current oral care result of the oral care device 1900, and the current oral care result is configured to represent a current oral care attainment of the oral care device 1900. After obtaining the target oral care information, when the oral care device 1900 stops outputting the cleaning driving signal to the motor (e.g., but not limited to, when the cleaning driving signal stops outputting automatically or when the cleaning driving signal stops outputting manually by the user), the target audio driving signal corresponding to the target oral care information is output to the motor based on the target oral care information, so as to control the motor to vibrate based on the target audio driving signal. Therefore, after the oral care is automatically ended or the user manually ends the oral care, the user is reminded which one of the oral care areas has not met the oral care standard or which one of the oral care areas needs to be cleaned again.

In some optional embodiments, as shown in FIG. 7, the target oral care information comprises a current oral care duration corresponding to a current oral care position of the oral care device 10. After obtaining the target oral care information, when the current oral care duration reaches the first predetermined duration, it is determined that the care on the current oral care position reaches the standard, and a first audio driving signal is output to the motor 30. The first audio driving signal is configured to prompt the care of the current oral care position reaches the standard

In some optional embodiments, as shown in FIG. 8, the target oral care information comprises a current oral care progress corresponding to the oral care device. After obtaining the target oral care information, a second audio driving signal is determined based on the current oral care progress; and the second audio driving signal is output to the motor. When a range of the current oral care progress changes, the second audio driving signal changes. Therefore, as the current oral care progress is gradually realized, for example but not limited to, the continuous increase in the range of the current oral care progress, different oral care achievements are gradually unlocked. The oral care achievements are reminded through the corresponding second audio driving signal, or the oral care achievements are reminded through different music or sound, thereby enhancing the oral care interest of the user, especially a child. The oral care achievements guide the user, especially the child, to gradually complete a whole oral care process.

In some optional embodiments, the number of frequencies corresponding to the target cleaning driving signal is less than the number of frequencies corresponding to the target audio driving signal. In this way, the sound, generated by the care component driven by the motor and corresponding to the target cleaning driving signal, is relatively simple, which ensures that the oral cleaning effect corresponds to the target cleaning driving signal. Moreover, the sound, generated by the care component driven by the motor and corresponding to the target audio driving signal, is more tonal. Optionally, the target cleaning driving amplitude of the target cleaning driving signal is greater than the target audio driving amplitude of the target audio driving signal. In this way, by making a swing amplitude of the care component driven by the driving motor corresponding to the target cleaning driving signal greater than the swing amplitude of the care component driven by the motor corresponding to the target audio driving signal, a problem of large noise generated by the care component when the motor swings is avoided, so that the audio output corresponding to the target audio driving signal is purer.

In some optional embodiments, the oral care device 1900 further comprises a motor driving piece 120. The target audio driving signal and the target cleaning driving signal are output by the motor driving piece 120, so that the motor driving piece (a type of hardware) is directly configured to drive the motor to generate sound vibrations or cleaning vibrations without changing an original hardware architecture of the oral care device.

Furthermore, the oral care device further comprises the care component 50. A volume of the sound generated by the motor 30 driven by the target audio driving signal is less than a target volume. The target volume may be, but is not limited to, 30 decibel, 35 decibel, etc. That is, the sound of the oral care device is small. The sound generated by the motor is transmitted to the ear of the user currently using the oral care device by bone conduction based on the care component. In this way, the sound generated by the motor driven by the target audio driving signal is clearly heard by the user, which reduces requirements for the motor to sound and avoids a problem of cracked sound when the motor directly generates a sound that is too loud.

Optionally, the target cleaning driving signal is a target cleaning square wave generated by superposition of sine waves of different frequencies, so a spectrum range of the target cleaning driving signal is wide, and the main energy of the target cleaning driving signal may be concentrated at around 300 Hz, thereby ensuring the oral cleaning effect corresponding to the target cleaning driving signal.

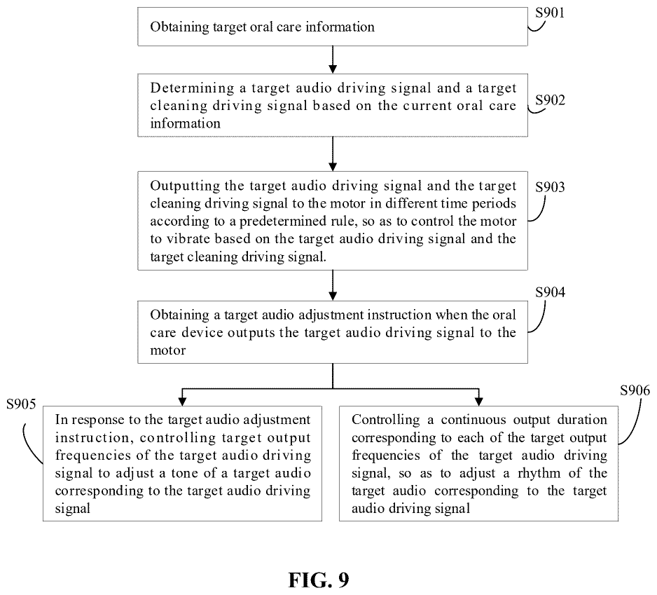

FIG. 9 is a flow chart of the control method of the oral care device according to another embodiment of the present disclosure. As shown in FIG. 9, the control method of the oral care device comprises steps S901-S906.

The step S901 comprises obtaining target oral care information.

In one embodiment, the step S901 is consistent with the step S201 and is not described in detail herein.

The step S902 comprises determining a target audio driving signal and a target cleaning driving signal based on the current oral care information.

In one embodiment, the step S902 is consistent with the step S202 and is not described in detail herein.

The step S903 comprises outputting the target audio driving signal and the target cleaning driving signal to the motor in different time periods according to a predetermined rule, so as to control the motor to vibrate based on the target audio driving signal and the target cleaning driving signal.

In one embodiment, the step S903 is consistent with the step S203 and is not described in detail herein.

The step S904 comprises obtaining a target audio adjustment instruction when the oral care device outputs the target audio driving signal to the motor.

In one embodiment, when the oral care device outputs the target audio driving signal to the motor, the user mat also, but is not limited to, adjust the audio output by the oral care device through at least one button on the oral care device. That is, the oral care device is enabled to obtain the target audio adjustment instruction.

It is understood that the target audio adjustment instruction may be, but is not limited to, obtained from a terminal connected to the oral care device.

The step S905 comprises in response to the target audio adjustment instruction, controlling target output frequencies of the target audio driving signal to adjust the tone of a target audio corresponding to the target audio driving signal.

In one embodiment, after the oral care device obtains the target audio adjustment instruction, the oral care device responds to the target audio adjustment instruction and controls the target output frequencies corresponding to the target audio driving signal to adjust the tone of the target audio corresponding to the target audio driving signal.

The step S906 comprises controlling a continuous output duration corresponding to each of the target output frequencies of the target audio driving signal, so as to adjust a rhythm of the target audio corresponding to the target audio driving signal.

In one embodiment, after the oral care device obtains the target audio adjustment instruction, the oral care device responds to the target audio adjustment instruction and controls the continuous output duration corresponding to the target audio driving signal of each of the target output frequencies, so as to adjust the rhythm of the target audio corresponding to the target audio driving signal.

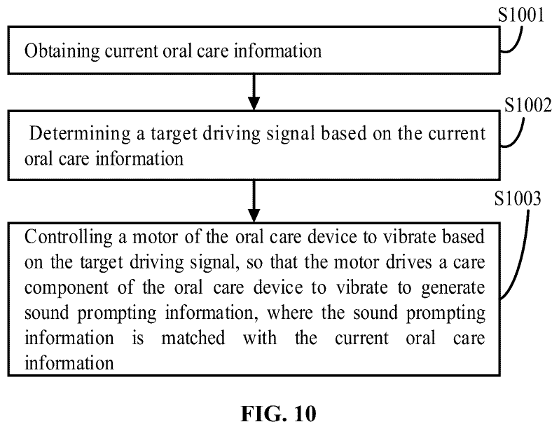

In conjunction with FIG. 1, the control method of the oral care device according to another embodiment of the present disclosure is introduced by taking the control method of the oral care device applied to an electric toothbrush as an example. Specifically, as shown in FIG. 10, the control method of the oral care device comprises steps S1001-S1003.

The step S1001 comprises obtaining current oral care information.

In one embodiment, during the oral care process, the oral care device is enabled to obtain the current oral care information through a detection element. The current oral care information comprises at least one of a current oral care position, a current target oral care pressure, a current oral care duration, a current motion amplitude, a current oral care progress, residual amount of dental plaque, a current oral care mode, a current oral care angle, a current oral care coverage of oral care data of the oral care device.

The step S1002 comprises determining a target driving signal based on the current oral care information.

It is understood that the target driving signal that is determined may change if the current oral care information corresponding to the oral care device 1900 changes, or the target driving signal that is determined may change if the current oral care state corresponding to the current oral care information changes.

The step S1003 comprises controlling a motor 30 of the oral care device to vibrate based on the target driving signal, so that the motor 30 drives a care component 50 of the oral care device 1900 to vibrate to generate sound prompting information. The sound prompting information is matched with the current oral care information.

In the present disclosure, the current oral care information of the oral care device 1900 is obtained, the target driving signal is determined based on the current oral care information, the motor of the oral care device is controlled to vibrate based on the target driving signal, so that the motor drives the care component of the oral care device to vibrate to generate the sound prompting information matched with the current oral care information. The present disclosure utilizes regular vibrations of the motor of the oral care device to generate the sound that matches the current oral care information to output interactive information when using the oral care device, which improves the synchronization of the prompting information of the oral care device and does not need to equip additional devices such as speakers and screens. When the motor 30 vibrates, the motor 30 drives the care component 50 to vibrate. When the care component 50 contacts the teeth, the sound is transmitted to the ears of the user in the form of bone conduction, avoiding the problem of configuring the speaker hole on the handle of the oral care device to affect the sealing performance of the handle and increase the manufacturing cost of the oral care device.

Optionally, the current oral care information comprises the current oral care position of the oral care device 1900, and the sound prompting information comprises at least one of an oral care technique corresponding to the current oral care position, an oral care posture, an oral care angle, an oral care amplitude. When the current oral care position changes, the sound prompting information changes. Therefore, by controlling the motor to drive the care component to generate different sound prompting information according to different current oral care positions, the user is reminded to use the current oral care technique, the current oral care posture, the current oral care angles, the current oral care range, etc. based on the current oral care position during the oral care process of the user, so as to assist the user to perform more scientific and effective oral care operations and improve oral care efficiency.

For instance, during the care process of the current oral care position A or before shifting from the current oral care position A, the motor is controlled to drive the care component to transmit the current oral care technique, the current oral care posture, the current oral care angle, the current oral care amplitude, and other sound prompting information corresponding to the current oral care position A to the user by bone conduction, thereby assisting the user to better complete the oral care operations for the current oral care position A.

In some optional embodiments, as shown in FIG. 11, the step 1003 of controlling the motor of the oral care device 1900 to vibrate based on the target driving signal, so that the motor drives the care component of the oral care device 1900 to vibrate to generate the sound prompting information comprises controlling the motor to drive the care component to asynchronously perform cleaning vibrations and audio vibrations matched with the current oral care information based on the target driving signal, so that the care component performs oral care based on the cleaning vibrations and generates the sound prompting information based on the audio vibrations. Therefore, the oral care device 1900 is able to efficiently complete the oral care operation by controlling the motor to drive the care component to perform the cleaning vibrations that match the current oral care information, and the oral care device 1900 is able to control the motor to drive the care component to perform the audio vibrations that match the current oral care information to generate the sound prompting information. In this way, the user may timely understand the current oral care information, synchronization of information prompts of the oral care device 1900 is improved, and the motor is controlled to synchronously drive the cleaning vibrations and audio vibrations of the care component to avoid influence of the audio vibrations of the care component on the cleaning vibrations. Thus, the oral care effect of the oral care device 1900 is ensured, and the influence of the cleaning vibrations of the care component on the audio vibrations is avoided, ensuring the fluency and effectiveness of the sound prompting information output by the care component.

For instance, after the oral care device 1900 is turned on or awakened, if the oral care instruction with a music mode is received, that is, the current oral care mode corresponding to the oral care device 1900 is obtained as the music mode (i.e., the current oral care information), the oral care device 1900 controls the motor 30 to drive the care component 50 to perform the cleaning vibrations matching the music mode based on the music mode. In addition, after the user selects the music mode of the oral care device to perform oral care for a current oral care duration that reaches the standard (for example, but not limited to reaching 3 minutes) or the current oral care duration corresponding to the current oral care position reaches the standard (for example, but not limited to reaching 30 seconds), the oral care device 1900 controls the motor 30 to stop vibrating to drive the care component to stop the cleaning vibrations matching the music mode, and controls the motor to drive the care component to generate corresponding music based on the audio vibrations matching the music mode. For example, every time the user reaches the standard for one of the oral care positions, the oral care device 1900 controls the motor 30 to drive the care component 50 to perform the audio vibrations corresponding to the one of the oral care positions to generate a corresponding standard music, thereby prompting the user that the current oral care has reached the standard or the current oral care position has reached the standard, which enhances the fun of the user using the oral care device 1900 for oral care.

Furthermore, the current oral care information comprises at least one of oral care positions, oral care duration, oral care forces, and oral care amplitudes of oral care information. The cleaning vibrations and the audio vibrations of the care component change with a change of the same oral care information in the current oral care information.

For example, but not limited to, as the current oral care force corresponding to the oral care device increases, in order to ensure the oral care effect of the oral care device and a prompt effect of the sound prompting information, a duty ration and/or an amplitude corresponding to the cleaning vibrations or the audio vibrations of the care component increases accordingly, thereby ensuring that the cleaning vibrations and the audio vibrations of the care component change synchronously with the change of the same oral care information in the current oral care information, thereby further improving the synchronization of the oral care device in performing oral care and providing information prompts.

In some optional embodiment, the target driving signal is an area changing reminding signal. The sound prompting information is area changing reminding information, for example but is not limited, the sound prompting information such as “please shift to the lower teeth area”, “the current oral care position has met the standard”, “please shift to the next oral care position”, etc. An output duration of the area changing reminding signal is less than a target duration.

That is, as the user changes the current oral area (the current oral care positions) for oral care, the care component of the oral care device may briefly leave the teeth. When the sound prompting information is the area changing reminding information, a duration of reminding vibrations driven by the motor based on the area changing reminding signal is less than the target duration (for example, 3 seconds, 5 seconds, etc.), ensuring that the area changing reminding information is output within the target duration, thereby ensuring that when the user switches the current oral care position for oral care, the area changing reminding information output before the care component leaves the teeth is effectively and completely obtained by the user. Therefore, a problem that the area changing reminding signal continues to be output for too long and the area changing reminding information has not been output completely before the care component leaves the teeth is avoided. Thus, a problem that the subsequent output of the area changing reminding information not being transmitted to the ears of the user resulting in an incomplete area changing reminding information is avoided.

Furthermore, as shown in FIG. 12, the current oral care information comprises a current oral care duration corresponding to a current oral care position of the oral care device, or the oral care information comprises the current oral care duration, and when the current oral care duration reaches a first predetermined duration, the target driving signal is the area changing reminding signal. For example, when the current oral care duration corresponding to the current oral care position (e.g., the upper left tooth area) reaches the first predetermined duration (e.g.,, but not limited to 30 seconds, 45 seconds, etc.), it is considered that the current oral care position of the teeth is fully cared,, and the target driving signal is determined to be the area changing reminding signal. Based on the area changing reminding signal, the oral care device controls the motor to drive the care component to generate corresponding area changing reminding information, such as but not limited to “the upper left tooth area is fully cared, please shift to the upper middle tooth area” and other voice reminding information. After the current oral care position is fully cared, the output of the area changing reminding information not only prompts the user that the current oral care position is fully cared, but also prompts the user that a next oral care position should be cared. Therefore, the oral care device is enabled to guide the user to perform oral care in accordance with a care order corresponding to the oral care positions. When the current oral care duration corresponding to the oral care device reaches the first predetermined duration (e.g., but not limited to 30 seconds, 45 seconds, etc.), it is determined that the user should switch to the next oral care position for oral care. At this time, the oral care device controls the motor based on the area changing reminding signal to drive the care component to generate the area changing reminding information corresponding to the next oral care position. For example, but not limited to, after every half minute of care, the oral care device automatically outputs a voice reminder message, such as “please switch to the next oral care position”, etc. Therefore, every time the user performs oral care for a certain period of time, the oral care device automatically reminds the user to switch the current oral care position to the next oral care position, avoiding a problem of low oral care efficiency caused by the user performing oral care at the same oral care position for a long time.

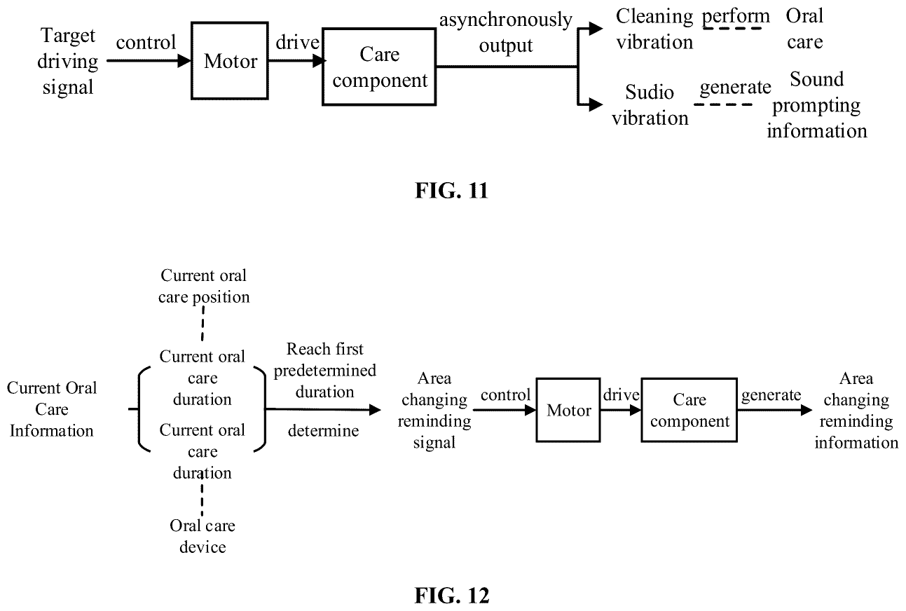

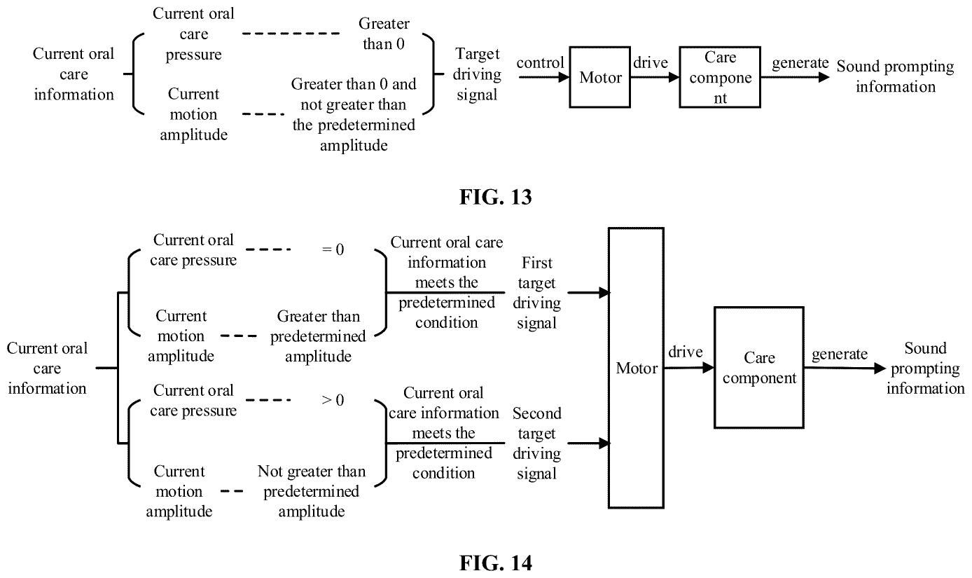

In some optional embodiments, as shown in FIG. 13, the current oral care information comprises a current oral care pressure and/or a current motion amplitude of the oral care device. The current oral care pressure may be detected by a pressure detection element and the current motion amplitude may be detected by a motion sensor, which are not limited in the present disclosure. The step S1003 of controlling the motor of the oral care device to vibrate based on the target driving signal, so that the motor drives the care component of the oral care device to vibrate to generate the sound prompting information comprises: when the current oral care pressure is greater than 0 and/or the current motion amplitude is greater than 0 and not greater than a predetermined amplitude, determining that the care component is in contact with the teeth and the user is currently using the oral care device for oral care, controlling the motor to vibrate based on the target driving signal, so that the motor drives the care component to vibrate to generate the sound prompting information. Therefore, it is ensured that the sound prompting information generated by the vibrations of the care component driven by the motor is transmitted to the ears of the user by bone conduction, thereby ensuring the effectiveness of transmission of the sound prompting information generated by the vibrations of the care component.

In some optional embodiments, the current oral care information comprises the current oral care pressure and/or the current motion amplitude of the oral care device 1900. Since the care component 50 leaves a tooth surface of the user, the sound prompting information generated by the vibrations of the care component 50 is unable to be effectively obtained by the user. Then, when the current oral care pressure is 0 and/or the current motion amplitude is greater than the predetermined amplitude, it is determined that the care component 50 of the oral care device 1900 is not in contact with the tooth surface. For example, if the oral care device 1900 is currently undergoing a large-scale area changing movement process, an output of the target sound prompting signal corresponding to the sound prompting information in the target driving signal is suspended to control the motor to drive the care component 50 to stop generating the vibrations of the sound prompting information, thereby stopping an output of the sound prompting information, so as to avoid a problem that the care component is currently not in contact with the tooth surface while the care component 50 still generates invalid vibrations corresponding to the sound prompting information. Therefore, the effectiveness of the information prompt of the oral care device 1900 is improved and the endurance of the oral care device 1900 is enhanced to a certain extent. Alternatively, when the current oral care pressure is 0 and/or the current motion amplitude is greater than the predetermined amplitude, it is determined that the care component 50 of the oral care device 1900 is not in contact with the tooth surface, then the output of the target driving signal is suspended, and the motor is directly controlled to stop vibration, so as to avoid a problem that the motor still vibrates for invalid oral care and/or invalid information prompts when the care component 50 is not in contact with the tooth surface, and enhance the endurance of the oral care device to a certain extent.

In some possible embodiments, as shown in FIG. 14, the current oral care information comprises at least one of the current oral care pressure of the oral care device 1900 and the current motion amplitude of the oral care device 1900. When the current oral care pressure is 0 and/or the current motion amplitude is greater than the predetermined amplitude, it is determined that the care component 50 of the oral care device 1900 is not in contact with the tooth surface, and a first target driving signal is determined based on the current oral care information. At this time, when the current oral care information meets the predetermined condition for generating the sound prompting information, the motor is controlled based on the first target driving signal to drive the care component 50 to vibrate and generate the sound prompting information. When the current oral care pressure is greater than 0 and/or the current motion amplitude is not greater than the predetermined amplitude, it is determined that the care component 50 of the oral care device 1900 is in contact with the tooth surface, a second target driving signal is determined based on the current oral care information. At this time, when the current oral care information meets the predetermined condition, the motor is controlled to drive the care component 50 to vibrate and generate the sound prompting information based on the second target driving signal. An amplitude of the first target driving signal is greater than an amplitude of the second target driving signal, and/or a frequency of the first target driving signal is greater than a frequency of the second target driving signal. Thus, when the care component 50 and the tooth surface of the user change from a fitted (contacted) state to a non-fitted (non-contacted) state and the current oral care information always meets the predetermined condition for outputting the sound prompting information, the loudness of the vibrations of the care component 50 is increased by increasing the amplitude and/or the frequency of the first target driving signal. That is, the motor is controlled to increase a vibration amplitude thereof to increase the loudness of the vibrations of the care component 50 by providing the first target driving signal with a larger amplitude and/or a larger frequency, so that the sound prompting information is heard during the oral care process when the care component 50 is not in contact with the tooth surface of the user. It is understood that the duty ratio of the driving signal corresponds to the vibration amplitude of the motor, that is, the loudness of the sound generated by the motor vibration. By changing the duty ratio, the output torque is changed, that is, the vibration amplitude of the motor is changed. The greater the duty ratio, the greater the vibration amplitude, and the louder the sound generated by the motor.

In some optional embodiment, the step S1003 of controlling the motor of the oral care device 1900 to vibrate based on the target driving signal, so that the motor drives the care component 50 of the oral care device 1900 to vibrate to generate the sound prompting information comprises: when the current oral care information meets the predetermined condition, controlling the motor 30 to drive the care component 50 to vibrate to generate the sound prompting information based on the target driving signal.

For instance, the current oral care information comprises, but is not limited to, a current oral care total duration of the oral care device 1900. When the current oral care total duration of the oral care device 1900 reaches a predetermined total duration (e.g., 3 minutes, 4 minutes, etc.), it is determined that the current oral care information meets the present condition, the motor is controlled to drive the care component 50 to vibrate to generate a current oral care up-to-standard prompting information based on the target driving signal, prompting the user that the current oral care meets the standard and there is no need to continue the oral care operation on the current oral care position. Alternatively, when the current total oral care duration of the oral care device does not reach the predetermined total duration (e.g., 3 minutes, 150 seconds, etc.), it is determined that the current oral care information does not meet the predetermined condition, then the motor is controlled to drive the care component 50 to vibrate based on the target driving signal to generate current oral care non-standard prompting information, prompting the user that the current oral care does not meet the standard and it is necessary to continue the oral care operation.

Optionally, the current oral care information comprises a current oral care duration corresponding to the current oral care position of the oral care device. When the current oral care duration reaches a second predetermined duration (e.g., 30 seconds, 45 seconds, etc.), it is determined that the current oral care information meets the present condition, the motor is controlled to drive the care component 50 to vibrate to generate the current oral care up-to-standard prompting information or the area changing reminding information based on the target driving signal.

The current oral care up-to-standard prompting information or the area changing reminding information may comprise the next oral care position that the user should switch to, thereby prompting the user that the current oral care position has reached the standard, and reminding the user which one of the oral care positions the care component 50 should be switched to after leaving the current oral care position. Alternatively, when the current oral care duration does not reach the second predetermined duration (e.g., 3 minutes, 150 seconds, etc.), it is determined that the current oral care information does not meet the predetermined condition, then the motor is controlled to drive the care component 50 to vibrate based on the target driving signal to generate the current oral care non-standard prompting information, prompting the user that the current oral care does not meet the standard and it is necessary to continue to fit the care component 50 to the current oral care position and continue to perform oral care on the current oral care position.

In some optional embodiments, the current oral care information comprises the current oral care pressure of the oral care device. And when the current oral care pressure or a pressure range of the current oral care pressure changes, the sound prompting information, generated by the care component 50 driven by the motor 30, changes; Therefore, the user is able to accurately understand the current oral care pressure through different sound prompting information, and the sound prompting information assists the user to perform the oral care operations more effectively.

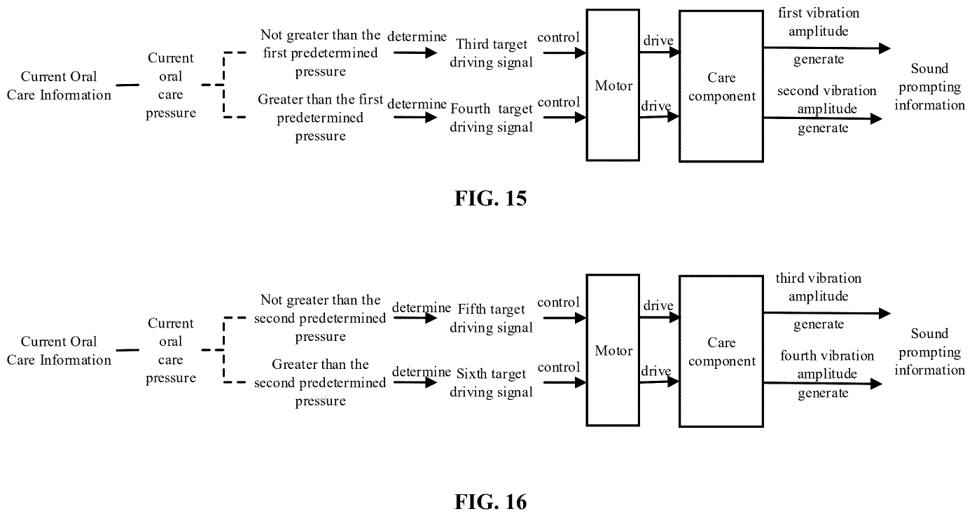

Optionally, as shown in FIG. 15, when the current oral care pressure is not greater than a first predetermined pressure, a third target driving signal corresponding to the current oral care information is determined based on the current oral care information. Based on the third target driving signal, the motor is controlled to drive the care component 50 to vibrate with a first vibration amplitude to generate the sound prompting information. When the current oral care pressure is greater than the first predetermined pressure, a fourth target driving signal corresponding to the current oral care information is determined based on the current oral care information. Based on the fourth target driving signal, the motor is controlled to drive the care component 50 to vibrate with a second vibration amplitude to generate the sound prompting information. An amplitude of the third target driving signal is greater than an amplitude of the fourth target driving signal, and the first vibration amplitude is greater than the second vibration amplitude. Thus, the first vibration amplitude that is relatively large is configured to compensate for a difference in loudness of the sound prompting information generated by the current oral care pressure that is relatively small, avoiding a problem that the current oral care pressure is not greater than the first predetermined pressure (i.e., the current oral care pressure is too small) causing the sound of the prompting information generated by the vibrations of the care component 50 being too low and the user cannot effectively hear it. Therefore, the sound prompting information generated by the vibrations of the care component 50 is clearly heard by the user, which improves the effectiveness of the oral care device in providing information prompts. The first predetermined pressure may be, but is not limited to, the pressure on the care component 50 when the user performs normal oral care. The first predetermined pressure may be set according to actual oral care situations, which is not limited thereto.

Optionally, as shown in FIG. 16, when the current oral care pressure is not greater than a second predetermined pressure, a fifth target driving signal is determined based on the current oral care information, and the motor is controlled based on the fifth target driving signal to drive the care component 50 to vibrate with a third vibration amplitude to generate the sound prompting information. The sound prompting information is related to the current oral care pressure, or the sound prompting information is related to other information in the current oral care information other than the current oral care pressure, and the embodiment of the present disclosure is not limited thereto. If the current oral care pressure is greater than the second predetermined pressure, it is determined that the current oral care pressure for the user is too high, and a sixth target driving signal is determined based on the current oral care information, and the motor is controlled based on the sixth target driving signal to drive the care component to vibrate with a fourth vibration amplitude to generate the sound prompting information, such as “the current oral care pressure is too high, please pay attention to adjust”, etc., to prompt the user to adjust the current oral care pressure in time to avoid a problem that the current oral care pressure is always in an overpressure state to cause damage to the gums of the user. A duty ratio of the sixth target driving signal is greater than a duty ratio of the fifth target driving signal, and the fourth vibration amplitude is greater than the third vibration amplitude. Therefore, when the current oral care pressure is greater than the second predetermined pressure, that is, the care component 50 of the oral care device 1900 is in an overpressure state, the fourth vibration amplitude that is relatively large is configured to compensate for reduction of the vibration amplitude caused by a fact that the vibrations of the care component are suppressed and the actual amplitude thereof is reduced caused by large current oral care pressure, thereby avoiding a problem that when the current oral care pressure is too large, an actual amplitude generated by the care component is reduced, resulting in the sound of the sound prompting information also decreasing. Thus, the sound prompting information generated by the vibrations of the care component 50 is clearly heard by the user, thereby improving the effectiveness of the oral care device in providing information prompts.

Furthermore, the target driving signal comprises a target sound driving signal and a target cleaning driving signal.

When the current oral care pressure changes from being not greater than the second predetermined pressure to being greater than the second predetermined pressure, it is determined that the care component currently changes from a non-overpressure state to the overpressure state, and an output amplitude of the target sound driving signal is increased to control the motor based on the target sound driving signal to increase the amplitude of the audio vibrations that drive the care component to generate the sound prompting information, thereby avoiding a problem that when the current oral care pressure is too large, the actual amplitude generated by the care component is reduced, resulting in the sound of the sound prompting information being reduced. Further, a problem that the output amplitude of the target cleaning driving signal is reduced to control the motor based on the target cleaning driving signal to reduce the amplitude of the cleaning vibrations that drive the care component to perform oral care is avoided, thereby reducing the problem that excessive oral care pressure causes damage to the gums of the user.

It is understood that the second predetermined pressure is greater than the first predetermined pressure.

Optionally, when the current oral care pressure is within a first predetermined pressure range, the duty ratio of the target driving signal decreases as the current oral care pressure increases. The first predetermined pressure range represents a pressure range where the oral care pressure is too small, such as but not limited to being not greater than the first predetermined pressure. That is, in the first predetermined pressure range where the oral care pressure is too small, as the current oral care pressure continues to decrease, the duty ratio of the target driving signal is continuously increased to compensate for reduction of the vibration amplitude of the care component, ensuring that the sound prompting information generated by the vibrations of the care component is heard by the user. When the current oral care pressure is within a second predetermined pressure range, the duty ratio of the target driving signal increases as the current oral care pressure increases. The second predetermined pressure range represents a pressure range where the oral care pressure is too large, such as but not limited to being greater than the second predetermined pressure. That is, in the second predetermined pressure range where the oral care pressure is too large, as the current oral care pressure continues to increase, the duty ratio of the target driving signal is continuously increased, which avoids a problem that the sound of the sound prompting information reduces due to continuous reduction of the actual vibration amplitude generated by the care component 50. A pressure value within the second predetermined pressure range is greater than a pressure value within the first predetermined pressure range.

In some optional embodiments, the current oral care information may comprise, but is not limited to, the current oral care position of the oral care device. The current oral care position may be detected based on a position detection element (such as, but not limited to, a multi-axis sensor, a camera, etc.) of the oral care device. The sound transmitted to the ears from transmission paths of different lengths is different. In order to avoid a problem of the sound prompting information heard by the user being unstable when caring for different oral care positions, when the current oral care position changes or an attribute of the current oral care position (i.e., a transmission distance from the current oral care position to the ears of the user) changes, the amplitude of the target driving signal changes, and the amplitude of the sound prompting vibrations generated by the care component driven by the motor driven by the target driving signal also changes. For example but is not limited thereto, the upper left tooth area and the upper right tooth area have the same transmission distance to the ears of the user, the attributes of the upper right tooth area have the same transmission distance are also the same, and the upper tooth area and the lower tooth area have different transmission distances to the ears of the user, the attributes of the upper tooth area and the lower tooth area are also different. Therefore, the sound differences caused by different oral care positions or different transmission distances are compensated, ensuring the uniformity of the sound of the sound prompting information when the oral care device provides information prompts, thereby improving the user experience during the oral care process of the oral care device.

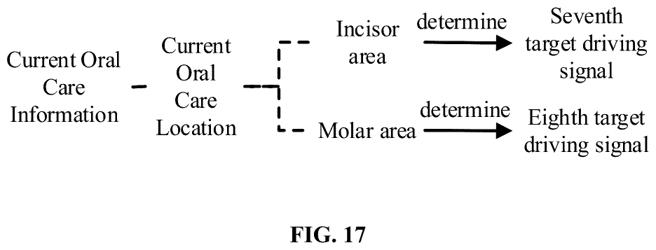

Exemplarily, as shown in FIG. 17, when the current oral care position is the incisor area, the target driving signal determined is a seventh target driving signal. When the current oral care position is the molar area, the target driving signal determined is an eighth target driving signal. The duty ratio of the seventh target driving signal is greater than the duty ratio of the eighth target driving signal. An incisor sound loudness generated by the motor driving the care component based on the seventh target driving signal is greater than a molar sound loudness generated by the motor driving the care component based on the eighth target driving signal. That is, by making the incisor sound loudness generated by the care component corresponding to the incisor area greater than the molar sound loudness generated by the care component 50 corresponding to the molar area, a problem that the prompting sound information transmitted from the incisor area to the user's ear being smaller than that in the molar area due to the incisor area being farther than the molar area in terms of the transmission distance to the ears of the user is avoided. Thus, the uniformity of the sound prompting information heard by the user is ensured when the oral care device is in the two different oral care positions of the incisor area and the molar area, and the user experience during the oral care process of the oral care device is improved.

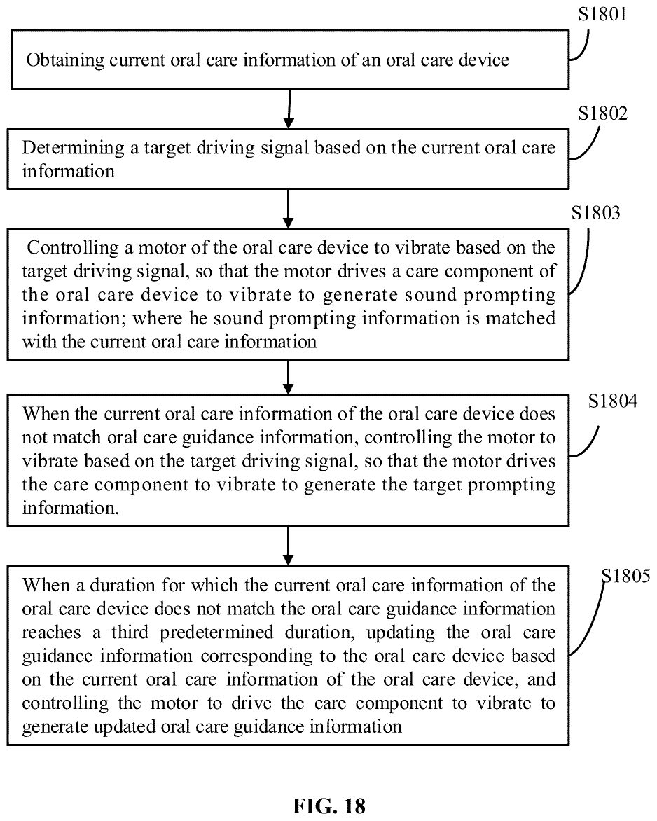

FIG. 18 is a flow chart of the control method of the oral care device according to another embodiment of the present disclosure. As shown in FIG. 18, the control method comprises steps 180-S1805.

The step S1801 comprises obtaining current oral care information.

In one embodiment, the step S1801 is consistent with the step S1001 and is not described in detail herein.

The step S1802 comprises determining a target driving signal based on the current oral care information.

In one embodiment, the step S1802 is consistent with the step S1002 and is not described in detail herein.

The step S1803 comprises controlling a motor of the oral care device to vibrate based on the target driving signal, so that the motor drives a care component 50 of the oral care device 1900 to vibrate to generate sound prompting information. The sound prompting information is matched with the current oral care information.

In one embodiment, the sound prompting information comprises oral care guidance information, and the oral care guidance information comprises a current oral care position where oral care is currently performed and/or a next oral care position to be switched. The oral care guidance information is determined based on predetermined oral care paths corresponding to different oral care positions and the current oral care information. The predetermined oral care paths may be, but is not limited to, guiding the user to first care for an upper teeth area, then a lower teeth area, or guiding the user to first care for a left teeth area, then a middle teeth area, and finally a right teeth area.

The step S1804 comprises when the current oral care information of the oral care device 1900 does not match the oral care guidance information, controlling the motor 30 to vibrate based on the target driving signal, so that the motor 30 drives the care component 50 to vibrate to generate the target prompting information.

In one embodiment, after controlling the motor to drive the care component to vibrate based on the target driving signal to generate corresponding oral care guidance information. If the current oral care information of the oral care device 1900 does not match the oral care guidance information (for example, but not limited to, the current oral care position is not the oral care position where oral care should be performed in the oral care guidance information, or the current oral care position after switching is not the next oral care position to be switched in the oral care guidance information), it is determined that the user is not currently performing oral care according to the oral care guidance information generated by the care component, and the motor is controlled based on the target driving signal to vibrate to drive the care component to vibrate to generate target prompting information, such as but not limited to target voice prompting information and/or target vibration prompting information, to remind the user to perform better oral care operations according to the oral care guidance information, so as to avoid a problem of low oral care efficiency. caused by users performing oral care operations aimlessly or randomly.

It is understood that the target prompting information may be the voice prompting information generated by the vibrations of the care component, or the target prompting information may be a vibration sound prompt corresponding to the care component, and the embodiment of the present disclosure is not limited thereto.

The step S1805 comprises when a duration for which the current oral care information of the oral care device does not match the oral care guidance information reaches a third predetermined duration, updating the oral care guidance information corresponding to the oral care device based on the current oral care information of the oral care device, and controlling the motor to drive the care component to vibrate to generate updated oral care guidance information.

Specifically, after controlling the motor to drive the care component to vibrate and generate the oral care guidance information based on the target driving signal, when the duration for which the current oral care information of the oral care device does not match the oral care guidance information reaches the third predetermined duration (for example but not limited to 5 seconds, 10 seconds, etc.), it means that the user currently does not intend to perform oral care according to the oral care guidance information. In this case, the oral care guidance information corresponding to the oral care device is updated based on the current oral care information of the oral care device. That is, a guidance path of the oral care device is replaned, and the motor is controlled to drive the care component to vibrate and generate the updated oral care guidance information, so as to realize synchronous change of the oral care guidance information according to an actual oral care situation of the user, thereby improving the flexibility and effectiveness of the oral care guidance.

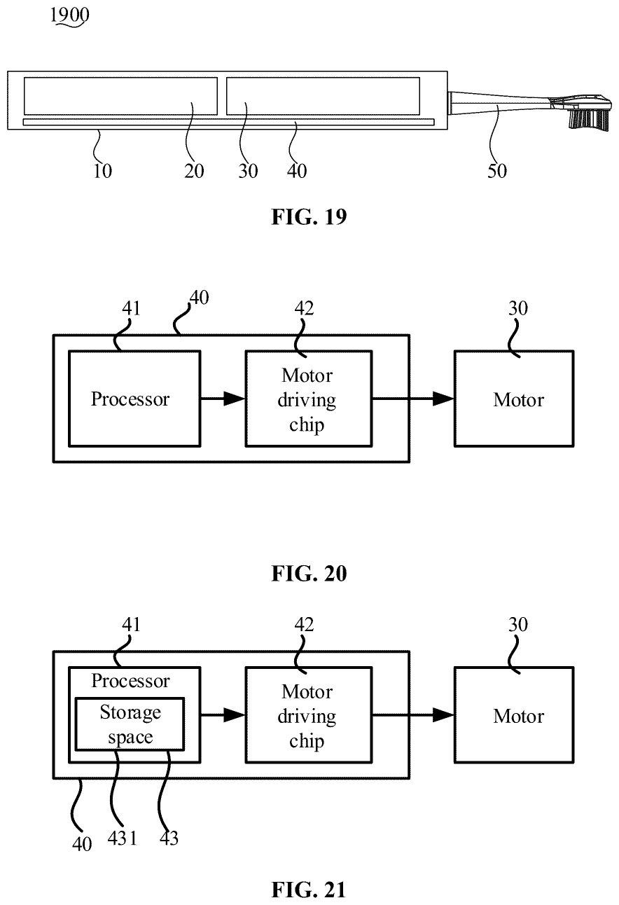

As shown in FIG. 19, embodiments of the present disclosure provide an oral care device 1900 configured to clean the oral cavity of the user, especially the teeth of the user. Furthermore, the present disclosure realizes sound generation by accurately controlling the vibrations of the motor (i.e., the motor 30) inside the oral care device 1900, thereby achieving functions such as voice reminders and music playback. The noise generated during a tooth brushing process is at least converted into a reminding sound or the music playback, thereby reducing noise interference during the tooth brushing process and improving comfort during the tooth brushing process.

As shown in FIG. 19, in some embodiments, the oral care device 1900 comprises a handle 10, a battery 20, a motor 30, a circuit board 40, and a brush head 50. The battery 20, the motor 30, and the circuit board 40 are disposed in the handle 10, and an output shaft of the motor 30 passes through the handle 10 and is connected to the brush head 50, so that the brush head 50 is driven to vibrate through the motor 30.

As shown in FIG. 20, the oral care device 1900 comprises a processor 41 and a motor driving chip 42 disposed on the circuit board 40. The processor 41, the motor driving chip 42, and the motor 30 are electrically connected in sequence. That is, the processor 41 is electrically connected to the motor driving chip 42, and the motor driving chip 42 is electrically connected to the motor 30.

The processor 41 is configured to send and receive electric signals and process the electric signals. For example, the processor 41 may be a microcontroller unit (MCU). The MCU is also known as a single-chip microcomputer or a single chip. The MCU appropriately reduces the frequency and specifications of a central process unit (CPU), and integrates peripheral interfaces such as memory, counter, USB, A/D conversion, universal asynchronous receiver/transmitter (UART), programmable logic controller (PLC), data memory access (DMA), and even liquid crystal display (LCD) drive circuits on a single chip to form a chip-level computer, which performs different combination controls for different application scenarios. A model of the processor 41 may be ESP32-C3, which is not limited thereto.

In some embodiments, the processor 41 is configured to send a driving signal to the motor driving chip 42. The driving signal comprises a cleaning signal or an audio signal. Alternatively, the driving signal comprises both the audio signals and the cleaning signals, and the cleaning signal is an exemplarily square wave signal. Different square wave signals have different frequencies or different duty rations. Different square wave signals correspond to different brushing modes. For example, the oral care device 1900 comprises a gentle mode, a moderate mode, and a strong mode with increasing brushing force in sequence. Corresponding to the three brushing modes, frequencies of the square wave signals are 200 Hz, 250 Hz, and 300 Hz, respectively, and vibration amplitudes of the square wave signals also increase in sequence to increase the brushing force synchronously. It is understood that the audio signal and the cleaning signal are combined in one signal. When the processor 41 sends a driving signal to the motor driving chip 42, the oral care device 1900 generates sound while cleaning.

In some embodiments, the processor 41 is configured to send the audio signal to the motor driving chip 42. According to characteristics of the audio signal, the audio signal is a regular audio signal or an irregular audio signal. A frequency and an amplitude of the regular audio signal show regular changes and carry voice information, music information, or sound effect information. The embodiment is described by taking the audio signal as the regular audio information as an example. The regular audio signals correspond to voice, music, sound effect, etc.

In the related art, a sound frequency band that the human ear can distinguish is 20 Hz-20 KHz. Sound has three characteristics: tone, loudness, and timbre. Loudness is determined by a vibration amplitude of a sound source. The larger the vibration amplitude, the louder the loudness (that is, the louder the volume); the tone is related to the vibration frequency. The higher the frequency, the higher the tone. The timbre is determined by the characteristics of the sound source itself, such as material, structure, etc. Different timbres have different characteristics of the waveform corresponding to the audio signals.

In the embodiment, when the processor 41 outputs the audio signal, the audio signal comprises vibration amplitude information and frequency information. That is, the audio signal has different frequency information or vibration amplitude information in different time periods, thereby causing the motor 30 to generate vibrations of different frequencies or vibration amplitudes, or the audio signal has different frequency information and vibration amplitude information in different time periods. When the audio signal is input to the motor 30, the frequency information thereof corresponds to the duty ratio of the audio signal, and the vibration amplitude information thereof corresponds to a series of voltage values of the audio signal, so the one of the audio signals drives the motor 30 to generate regular vibrations. When the vibration frequency and vibration amplitude of the motor 30 correspond to the frequency information and vibration amplitude information of the voice, the music or a sound effect to be played, the motor 30 generates the voice, the music or the sound effect of corresponding loudness through the medium, so that the motor 30 emits sound through the medium.

It should be noted that the processor 41 is able to output the cleaning signal and the audio signal to the motor driving chip 42 at the same time, so that the motor 30 is controlled by the cleaning signal and the audio signal at the same time. While the motor 30 performs cleaning movement (cleaning vibrations) according to the cleaning signal, the motor 30 also generates regular vibrations according to the audio signal and emits sound through the medium.

When the driving signal only comprises the cleaning signal, the motor driving chip 42 is configured to amplify the cleaning signal to amplify an output power. When the driving signal only comprises the audio signal, the motor driving chip 42 is configured to amplify the audio signal to amplify the output power. When the driving signal comprises both the cleaning signal and the audio signal, the motor driving chip 42 is configured to amplify the cleaning signal and the audio signal to amplify the output power.

It should be noted that a reason why the driving signal needs to be amplified is that the vibration amplitude of the driving signal output by the processor 41 is relatively small, driving ability is weak, and the driving signal is unable to drive the motor 30 to vibrate. The driving signal is amplified by the motor driving chip 42 to amplify the output power, thereby improving the driving ability of the driving signal, so that the motor 30 is able to vibrate under the drive of the driving signal. When the driving signal comprises the cleaning signal, a cleaning movement is realized, and when the driving signal comprises the audio signal, the motor 30 vibrates and emits the sound through the medium. Optionally, a model of the motor driving chip 42 is UPT8517.

It should be emphasized that a circuit or a module for amplifying the driving signal has various options. In some embodiments, the motor driving chip 42 is replaced by an audio power amplifier chip, and the driving signal is amplified by the audio power amplifier chip. The audio power amplifier chip has characteristics of high fidelity and low distortion, which improves the output quality of an amplified audio signal and ultimately improves the sound quality.

In comparison, when the driving signal is amplified by the motor driving chip 42, for the same amplification factor and driving capability, the motor driving chip 42 consumes less power and generates less heat than the audio power amplifier chip. In addition, after the motor driving chip 42 amplifies the driving signal, the sound quality is not as good as that of the audio power amplifier chip. However, the motor driving chip 42 has a higher precision control capability and is able to control the motor 30 more accurately. Compatibility between the motor driving chip 42 and the motor 30 is improved by adjusting, so that a working state of the motor 30 is better and the oral care device 1900 has a better cleaning effect.

Therefore, a focus is on requirements for the long battery life of the oral care device 1900, requirements for better teeth cleaning effects, and the use of the motor 30 as the sound source, high fidelity and low distortion rate parameters of the driving signal are not sensitive. That is, the sound quality of the sound emitted by amplifying the driving signal through the motor driving chip 42 is not much different from that of amplifying the driving signal through the audio power amplifier chip. Therefore, the motor driving chip is selected to amplify the driving signal so as to realize the regular vibrations of the motor 30 and emit sound through the medium on the basis of achieving the longer battery life and better teeth cleaning effects of the oral care device 1900. If the focus is on improving the sound quality of the sound emitted by the regular vibrations of the motor 30 through the medium, the audio power amplifier chip is selected to amplify the driving signal.

In some embodiments, after the motor 30 receives an amplified cleaning signal, the motor 30 is controlled by the amplified cleaning signal to perform a cleaning motion. When the motor 30 performs the cleaning motion, the brush head 50 is driven to vibrate synchronously through the output shaft, and when the brush head 50 contacts the oral cavity of the user, the oral cavity of the user is cleaned to realize the teeth cleaning effect.

In some embodiments, after receiving the amplified audio signal, the motor 30 is controlled by the amplified audio signal to generate the regular vibrations, and emits the sound with a tone and rhythm through the medium. Specifically, since the audio signal is the regular audio signal and comprises the regular frequency information and regular vibration amplitude information, the regular frequency information determines the vibration frequency of the motor 30, and a duration corresponding to a certain vibration frequency corresponds to a duration of the tone. Different tones may have the same or different durations to form a corresponding rhythm. That is, the regular frequency information causes the motor 30 to generate regular vibrations, and the regular vibrations emit the sound with the tone and rhythm through the medium.

Optionally, the medium may be air. That is, the motor 30 transmits the regular vibrations to the air to form sound waves and transmits the sound waves to the human ears. Alternatively, the motor 30 transmits the regular vibrations to the brush head 50 through the output shaft, the brush head 50 transmits the regular vibrations to the air to form the sound waves and transmits the sound waves to the human ears. Alternatively, the brush head 50 contacts the teeth of the user and transmits the regular vibrations to the human ears by bone conduction.

In one embodiment, the regular vibrations of the motor 30 correspond to at least one of the voice, the music, and the sound effect. The motor 30 is able to transmit the regular vibrations to the brush head 50 through the output shaft. When the brush head 50 contacts the oral cavity of the user (such as the teeth or the gums), the brush head 50 further transmits the regular vibrations to the oral cavity, and the oral cavity further transmits the regular vibrations to the inner ears of the user, thereby transmitting the sound emitted by the motor 30 to the user in the bone conduction manner. Specifically, the bone conduction is a sound conduction method that converts sound into mechanical vibrations of different frequencies and transmits the sound waves through the human skull, bony labyrinth, inner ear lymph, spiral organ, and auditory center.

Compared to transmitting the sound to the ears through the medium such as air, under the condition that the amplification factor of the motor driving chip 42 does not change, a solid sound transmission method such as bone conduction allows the user to hear louder and clearer sounds. In other words, compared to air transmission, under a premise of being able to hear sounds of the same volume or loudness, the motor driving chip 42 only needs to use a smaller amplification factor to drive the motor 30 to emit the sound of corresponding loudness through bone conduction, thereby reducing the energy consumption of the motor driving chip 42, extending the use time of the oral care device 1900, and improving the endurance of the oral care device 1900. In addition, compared to transmitting the sound through the air, the bone conduction saves many steps in sound wave transmission and realizes clear sound restoration in a noisy environment, and the sound waves do not affect others because of diffusion in the air. VY transmitting the sound through the bone conduction also helps a hearing-impaired to hear the sound corresponding to the regular vibrations of the motor 30.

In summary, in the embodiment, the processor transmits the driving signal to the motor driving chip 42, and the driving signal comprises the audio signal, or the driving signal comprises the audio signal and the cleaning signal. The motor driving chip 42 amplifies the driving signal to amplify the output power. When the driving signal comprises the audio signal, the amplified audio signal drives the motor 30 to produce the regular vibrations. The regular vibrations are transmitted through the medium, such as the air or the brush head 50, to emit the sound with the tone and rhythm, thereby realizing the output of the voice, the music or the sound effect. In the related art, the motor 30 needs to be driven by a single-frequency driving signal and the motor drives the brush head 50 to vibrate in order to realize the teeth cleaning effect. In the embodiment, the oral care device breaks with conventional thinking, and directly drives the motor 30 to vibrate regularly through the audio signal, while eliminating the noise caused by the single-frequency driving signal, realizing the output of the voice, the music or the sound effect, thereby improving the comfort of the user when brushing their teeth.

Furthermore, compared to the audio power amplifier chip driving the motor 30 to vibrate, the motor driving chip 42 is matched with the motor 30, and the motor driving chip 42 has the control capability of higher accuracy for the motor 30. The motor driving chip 42 and the motor 30 are more compatible by adjusting. For the motor driving chip 42 and the motor 30 that are adapted to each other after adjustment, the working state of the motor 30 is better. When the motor driving chip 42 drives the motor 30 to vibrate, the motor driving chip 42 generates less heat and has higher power efficiency. Therefore, the oral care device 10 has a stronger endurance.

In addition, compared to transmitting the sound to the ears through the air, in the embodiment, the sound is transmitted to the ears of the user by bone conduction. Under the condition that the power amplification of the motor driving chip 42 is unchanged, the user is enabled to hear louder and clearer sound through the solid sound transmission method of bone conduction. In other words, compared to air transmission, under the premise of being able to hear the sound of the same volume or loudness, the motor driving chip 42 only needs to drive the motor 30 and transmit the sound of the corresponding loudness of a bone conduction medium through a smaller amplification of the driving signal, thereby reducing the energy consumption of the motor driving chip 42, extending the use time of the oral care device (such as an audio electric toothbrush) 1900, and improving the endurance.

It should be noted that, the processor 41 may send only one of the cleaning signal or the audio signal to the motor driver chip 42 without modulation, or, the processor 41 may send both the cleaning signal and the audio signal to the motor driver chip 42 at the same time without modulation, so that the motor driving chip 42 drives the motor 30 to vibrate regularly while performing the cleaning motion and emitting the sound through medium conduction.

Alternatively, the processor 41 modulates the cleaning signal and the audio signal before sending the cleaning signal and the audio signal to the motor driving chip 42. That is, after the processor 41 modulates the cleaning signal and the audio signal into a space vector pulse width modulation signal (SVPWM), the SVPWM signal is sent to the motor driving chip 42, so that the motor driving chip 42 drives the motor 30 to perform the cleaning motion while vibrating regularly to emit the sound through the medium conduction. When the cleaning signal and the audio signal are sent to the motor driving chip 42 without modulation, the audio signal may be distorted due to superposition of the cleaning signal on the audio signal, and finally the sound emitted by the motor 30 may be distorted. On the contrary, after the cleaning signal and the audio signal are modulated into the SVPWM signal, the SVPWM signal is sent to the motor driving chip 42 to drive the motor 30 to vibrate regularly, a problem of distortion of the audio signal and the sound is effectively avoided. That is, compared with sending the cleaning signal and the audio signal to the motor driving chip 42 without modulation, by modulating the cleaning signal and the audio signal into the SVPWM signal and sending the SVPWM signal to the motor driving chip 42, the sound quality of the oral care device 1900 is improved.

In addition, when the cleaning signal and the audio signal are sent to the motor driving chip 42 together without modulation, since the cleaning signal and the audio signal are independent from each other, the sending timings of the cleaning signal and the audio signal need to be controlled separately, and the control process thereof is relatively complicated. After the cleaning signal and the audio signal are modulated into the SVPWM signal, the cleaning signal and the audio signal are modulated into one signal (i.e., the SVPWM signal). It is only necessary to control the sending timing of the SVPWM signal. The control algorithm thereof is relatively simple. Therefore, the control process of the processor 41 outputting the driving signal is simplified.

As shown in FIGS. 21-22, in some embodiments, the oral care device 1900 further comprises a storage module 43 configured to store audio files corresponding to the audio signals. The processor 41 generates the audio signals corresponding to the audio files based on the audio file in the storage module 43. A format of the audio files is not limited in the present disclosure. For instance, the audio files are in a formats of MP3, WAV, WMA, MP2, Flac, MIDI, RA, APE, AAC, CDA, MOV, etc.

It should be noted that, in some embodiments, when only the processor 41 is required to output the cleaning signal (generally a PWM square wave signal), the cleaning signal is generated in real time and sent to the motor driving chip 42. In this case, there is no need to set up the storage module 43 to pre-store the cleaning signal. When the processor 41 is required to output the audio signal, the storage module 43 is set up.

On the one hand, the storage module 43 may pre-store different audio files. Only when the sound is needed to be emitted, the processor 41 calls the target audio file corresponding to the target audio signal that is pre-stored in the storage module 43 and generates the corresponding target audio signal, so the oral care device 1900 selects the sound timing more flexibly. If the storage module 43 is not set, in order to realize the sound of the oral care device 1900, the oral care device 1900 must receive the target audio file or the target audio signal from the external terminal in real time, and the oral care device 1900 must be able to communicate with the external terminal, which has high hardware cost and higher power consumption.

On the other hand, the storage module 43 may store the audio files of various sizes and formats, so that the sound output by the oral care device 1900 is more diversified. For example, the oral care device 1900 may output the sound for a longer time, and may output a whole song as background music, so that the user is enabled to enjoy non-repeated background music during the teeth brushing process. For another example, the storage module 43 stores the audio files of pattern sounds corresponding to different brushing modes, so that under different brushing modes, the oral care device 1900 is able to output different pattern sounds to facilitate the user to identify a switching process of the brushing mode or identify a current brushing mode.

As shown in FIG. 21, in one embodiment, the storage module 43 may be a storage space 431 on the processor 41. That is, the processor 41 comprises the storage space 431. Exemplarily, when a model of the processor 41 is ESP32-C3, the processor 41 has a flash memory with a storage space of 2M. The flash memory is a non-volatile memory device. Compared with an external memory, an internal memory, such as the flash memory that is directly connected to the processor 41, has a fast reading and writing speed. The internal memory is configured to store instructions and data of the currently running program, and directly exchanges information with the processor 41, so that the processing speed is accelerated.

Alternatively, as shown in FIG. 22, the storage module 43 maybe a memory 432 electrically connected to the processor 41. The memory 432 may be an internal memory or an external memory, and a size of the memory 432 is designed according to actual needs, so that the memory 432 is allowed to store the audio files with higher sound quality and longer playback time, or the memory 432 is allowed to store a variety of different sounds. In comparison, the storage space 431 on the processor 41 is generally small, while the memory 432 may be provided with the required storage space as needed. Therefore, the audio files of various sizes and formats may be stored, making the sound output by the oral care device 1900 more diverse, providing the user with more sound output options.

In some embodiments, each of the audio files stored in the storage module 43 corresponds to a corresponding reminding sound emitted by the motor 30. Exemplarily, the reminding sound comprises the area changing reminding sound. When the cleaning time period of the brush head 50 in a fixed area reaches a predetermined time period, such as 5-30 seconds, the area changing reminding sound is output through the motor 30. For example, the area changing reminding sound, such as “please change the area to brush your teeth”, is configured to remind the user to move the brush head 50 in time and change the current oral care position.

Exemplarily, the reminding sound comprises an overpressure reminding sound. During the teeth brushing process, the user presses the brush head 50 on the teeth or on the gums. By setting a pressure sensor on the brush head 50 or a structure connected to the brush head 50, the pressure sensor detects a pressing force of the brush head 50 on the teeth or the gums. When the pressing force is greater than the predetermined force, it indicates that the pressing force is too large, which may damage the gums or the teeth. At this time, the motor 30 outputs the overpressure reminding sound, such as “please brush your teeth gently” to remind the user to reduce the pressing force of brushing.

Exemplarily, the reminding sound comprises an improper operation reminding sound. During the teeth brushing process of the oral care device 1900, the user may have some improper operations, such as brushing the teeth too many times, brushing the teeth at an incorrect angle, brushing the teeth by an incorrect method, etc. The improper operations may damage the gums and the teeth. At this time, the motor 30 vibrates regularly and outputs the improper operation reminding sound through the medium conduction to remind the improper operations of the user and effectively protect the gums and the teeth.

In some embodiments, the audio files correspond to pattern sounds corresponding to the brushing modes controlled by the motor 30, and different brushing modes correspond to different pattern sounds. Exemplarily, as mentioned above, the brushing modes of the oral care device 1900 comprise the gentle mode, the moderate mode, and the strong mode that are of increasing brushing force. For different brushing modes, the motor 30 outputs different pattern sounds, and the pattern sounds may comprise at least one of the voice, the music, and the sound effects. For example, corresponding to the three brushing modes of the gentle mode, the moderate mode, and the strong mode with increasing brushing force, the motor 30 outputs three sound effects with increasing tones, so as to remind the user of a current brushing mode executed by the oral care device 1900 through different sound effects.

As shown in FIG. 22, in some embodiments, the oral care device 1900 further comprises a communication module 60 electrically connected to the processor 41. The communication module 60 is configured to establish a communication connection between the oral care device 1900 and the external terminal. After establishing the communication connection with the external terminal through the communication module 60, the target audio file is sent to the oral care device 1900 by operating the external terminal, or a current control instruction is sent to the external terminal by operating the oral care device 1900, so that the external terminal is able to send the target audio file to the oral care device 1900, and the oral care device 1900 is able to receive the target audio file through the communication module 60. That is, the processor 41 receives the target audio file sent by the external terminal through the communication module 60. Subsequently, the processor 41 generates a target audio signal according to the target audio file sent by the external terminal and sends the target audio signal to the motor driving chip 42, thereby controlling the motor 30 to vibrate regularly and generate the sound through the medium.

The communication module 60 may be a wired connection module, such as a Type-C interface, a Type-A interface, etc. The communication module 60 may also be a wireless connection module, such as a BLUETOOTH communication module, a WIFI communication module, and a Zigbee communication module, etc.

In some embodiments, after the processor 41 receives the target audio file sent by the external terminal through the communication module 60, the processor 41 generates the target audio signal in real time based on the target audio file, and after the motor driving chip 42 amplifies the target audio signal, the processor 41 drives the motor 30 to generate the sound in real time.

In other embodiments, after the processor 41 receives the target audio file sent by the external terminal through the communication module 60, the processor 41 stores the target audio file and calls the target audio file when needed. Specifically, the oral care device 1900 comprises the storage module 43, and the storage module 43 is electrically connected to the processor 41. After receiving the target audio file sent by the external terminal through the communication module 60, the processor 41 stores the target audio file in the storage module 43. When the target audio signal needs to be output at a later time, the processor 41 calls the target audio file in the storage module 43.

Exemplarily, the target audio file received by the processor 41 from the external terminal through the communication module 60 is one of the audio files corresponding to the reminding sound. Therefore, the reminding sound corresponding to the target audio file needs to be output only when an area changing reminder, an overpressure reminder, or an improper operation reminder is required. Therefore, the processor 41 calls the target audio file and finally drives the motor 30 to output the reminding sound only when conditions of the area changing reminder, the overpressure reminder, or the improper operation reminder are met.

It is understood that when there is no need to update the audio files in the storage module 43, or the storage space of the storage module 43 is large enough to store all of the audio files, the communication module 60 is allowed to be omitted.

In order to reduce the storage space, common audio file formats such as MP3, WMA, WAV, APE, FLAC, OGG, AAC, etc., are all in audio compression formats to reduce a file size. When audio playback is required, one of the audio files in the audio compression formats are decoded first to obtain an original audio information before the sound is played.

Therefore, in some embodiments, as shown in FIG. 22, the oral care device further comprises an audio decoding module 70. The audio decoding module 70 is electrically connected to the processor 41 or integrated in the processor 41. The audio decoding module 70 is configured to decode the target audio file called out by the processor 41 from the storage module 43, or to decode the target audio file received by the processor 41 through the communication module 60 in real time to generate the target audio signal (i.e., the original audio information).

For different audio file formats, the audio decoding module 70 has different forms. Exemplarily, for the audio files in the MP3 format, the audio decoding module 70 may have a module of a corresponding MP3 encoding and decoding algorithm; for the audio files in the WAV format, the audio decoding module 70 may be a DAC (digital-to-analog converter) module or a PWM (pulse width modulation) module that is built into the processor 41 or that is independent from the processor 41. In other embodiments, the target audio file may be decoded by the external terminal to generate the target audio signal, and the target audio signal is sent to the oral care device 1900 to drive the motor 30 to vibrate regularly and generate the sound through the medium. At this time, the audio decoding module 70 may be removed.

In some embodiments, a power amplification factor of the motor driving chip 42 is not less than 30 and not greater than 45, so that the motor driving chip 42 is able to amplify the driving signals by a sufficient multiple, so that the driving signals have a sufficient vibration amplitude (or output power), so as to drive the motor 30 to vibrate, and the driving signals ensure that the motor 30 has a suitable loudness when the motor vibrates regularly and generates the sound through the medium. Therefore, the user is enabled to hear the sound with sufficient loudness clearly, and the sound is not cracked due to excessive loudness.

When the power amplification factor of the motor driving chip 42 is less than 30, the power amplification factor of the motor driving chip 42 is too small, and the amplified driving signals are unable to drive the motor 30 to vibrate, or the loudness of the sound generated by regular vibrations of the motor 30 under driving of the amplified driving signals and transmitted through the medium is not enough, which makes it difficult for the user to hear the sound corresponding to the regular vibrations. When the power amplification factor of the motor driving chip 42 is greater than 45, the power amplification factor of the motor driving chip 42 is too large, and the loudness of the sound, generated by the regular vibrations of the motor 30 under driving of the amplified driving signals and transmitted by the medium, is too loud, resulting in a sharp increase in the probability of distortion of the sound, which ultimately makes it difficult for the user to hear the sound corresponding to the regular vibrations.

In some embodiments, a voltage amplification factor of the motor driving chip is not less than 1.2 and is not greater than 1.8. In this way, the motor driving chip 42 is able to amplify a voltage of the driving signals by a sufficient multiple, so that the driving signals have sufficient vibration amplitude to drive the motor 30 to vibrate, and the motor 30 has a suitable loudness when the motor 30 vibrates regularly and transmits the sound through the medium. Therefore, the user is enabled to hear the sound with sufficient loudness clearly, and the sound is not cracked due to excessive loudness.

When the voltage amplification factor of the motor driving chip 42 is less than 1.2, the voltage amplification factor of the motor driving chip 42 is too small, and the amplified driving signals are unable to drive the motor 30 to vibrate, or the loudness of the sound generated by regular vibrations of the motor 30 under driving of the amplified driving signals and transmitted through the medium is not enough, which makes it difficult for the user to hear the sound corresponding to the regular vibrations. When the voltage amplification factor of the motor driving chip 42 is greater than 1.8, the voltage amplification factor of the motor driving chip 42 is too large, and the loudness of the sound, generated by the regular vibrations of the motor 30 under driving of the amplified driving signals and transmitted by the medium, is too loud, resulting in the sharp increase in the probability of distortion of the sound, which ultimately makes it difficult for the user to hear the sound corresponding to the regular vibrations.

When the power amplification factor of the motor driving chip 42 is less than 30, the power amplification factor of the motor driving chip 42 is too small, and the amplified driving signals are unable to drive the motor 30 to vibrate, or the loudness of the sound generated by regular vibrations of the motor 30 under driving of the amplified driving signals and transmitted through the medium is not enough, which makes it difficult for the user to hear the sound corresponding to the regular vibrations. When the power amplification factor of the motor driving chip 42 is greater than 45, the power amplification factor of the motor driving chip 42 is too large, and the loudness of the sound, generated by the regular vibrations of the motor 30 under driving of the amplified driving signals and transmitted by the medium, is too loud, resulting in a sharp increase in the probability of distortion of the sound, which ultimately makes it difficult for the user to hear the sound corresponding to the regular vibrations.

In some embodiments, a current amplification factor of the motor driving chip is not less than 16 and is not greater than 24. In this way, the motor driving chip 42 is able to amplify a current of the driving signals by a sufficient multiple, so that the driving signals have sufficient driving ability to drive the motor 30 to vibrate, and the motor 30 has the suitable loudness when the motor 30 vibrates regularly and transmits the sound through the medium. Therefore, the user is enabled to hear the sound with sufficient loudness clearly, and the sound is not cracked due to excessive loudness.

When the current amplification factor of the motor driving chip 42 is less than 16, the current amplification factor of the motor driving chip 42 is too small, and the amplified driving signals are unable to drive the motor 30 to vibrate, or the loudness of the sound generated by regular vibrations of the motor 30 under driving of the amplified driving signals and transmitted through the medium is not enough, which makes it difficult for the user to hear the sound corresponding to the regular vibrations. When the current amplification factor of the motor driving chip 42 is greater than 24, the current amplification factor of the motor driving chip 42 is too large, and the loudness of the sound, generated by the regular vibrations of the motor 30 under driving of the amplified driving signals and transmitted by the medium, is too loud, resulting in the sharp increase in the probability of distortion of the sound, which ultimately makes it difficult for the user to hear the sound corresponding to the regular vibrations.

In some embodiments, the power supply voltage of the motor driver chip 42 is not less than 2.4V and not greater than 6V. Since a power supply voltage of the motor driving chip 42 affects the power amplification factor, the voltage amplification factor, and the current amplification factor of the motor driving chip 42, the power amplification factor, the voltage amplification factor, and the current amplification factor of the motor driving chip 42 are adjusted by adjusting the power supply voltage. By setting the power supply voltage to be not less than 2.4V and not greater than 6V, the amplification factors of the motor driving chip 42 are enabled to fall within the corresponding range, thereby achieving the above-mentioned effects. By adjusting the amplification factors by adjusting the power supply voltage, the control process is simple and the cost is low.

In some embodiments, the motor 30 is controlled by the amplified audio signals to vibrate regularly and transmit the sound through the medium, and the sound transmitted through the air is not greater than 20 decibels. In this way, the user using the oral care device 1900 to brush the teeth is able to hear the sound output by the oral care device 1900 through bone conduction, and other people are unable to hear the sound output by the oral care device 1900 through air transmission. That is, only the user currently using the oral care device 1900 is allowed to hear the sound output by the oral care device 1900, which is conducive to protecting the privacy of the user currently using the oral care device 1900, avoids noise to other people, reduces the power consumption of the oral care device, and improves the battery life of the oral care device.

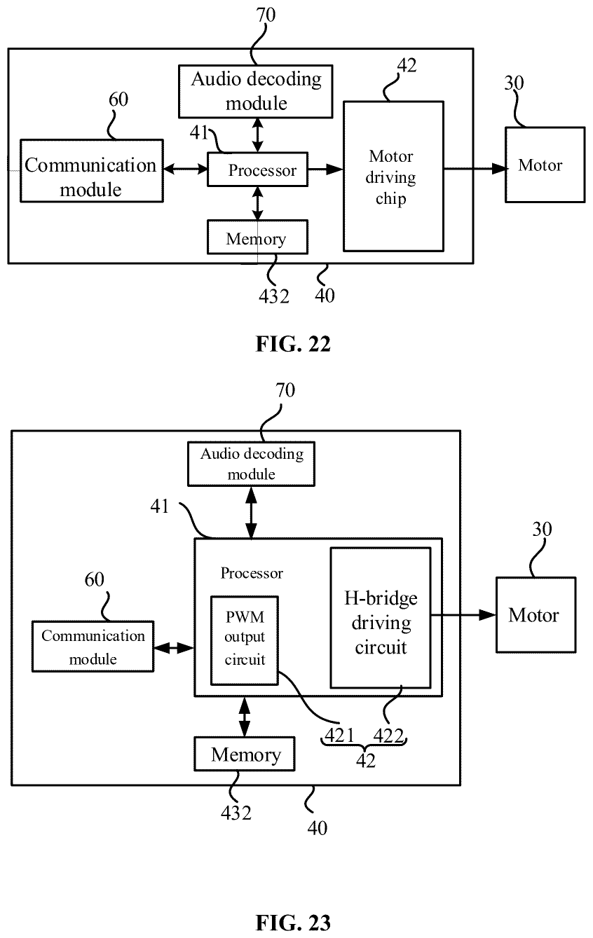

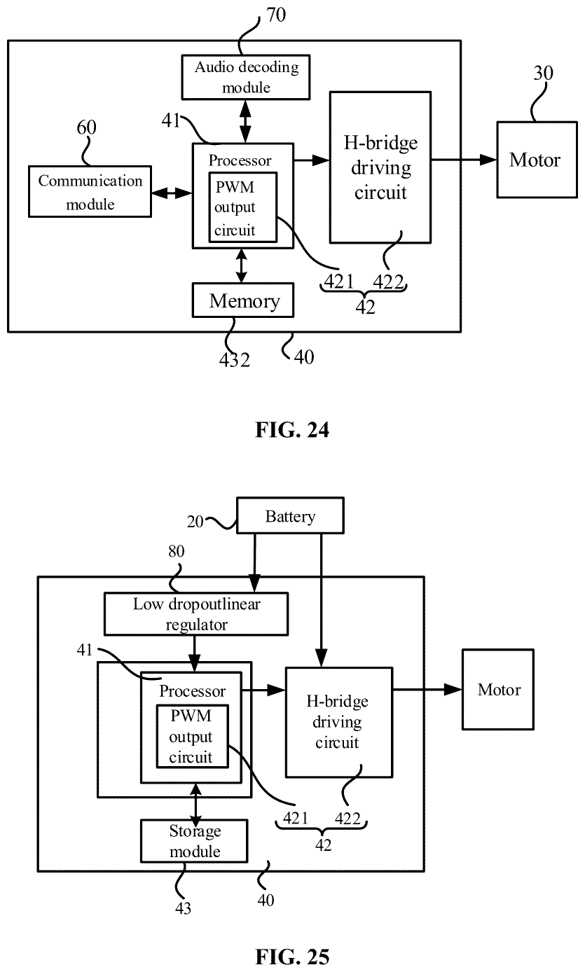

As shown in FIGS. 23-24, in some embodiments, the motor driving chip 42 comprises an H-bridge driving circuit 422 and a PMW output circuit 421. The PWM output circuit 421 is electrically connected to the processor 41 and is configured to output the driving signals to the H-bridge driving circuit 422. Specifically, the PWM output circuit 421 is configured to output the driving signals in a form of PWM signals to control a speed of the motor 30. Different PWM signals have different duty ratios, voltage values, and current values, so the speed of the motor 30 is adjusted by the H-bridge driving circuit 422.

The H-bridge driving circuit 422 is electrically connected to the motor 3 and the PWM output circuit 421. The H-bridge driving circuit 422 is configured to control steering and start-stop of the motor 30. That is, the H-bridge driving circuit 422 is configured to control the motor 30 to start and vibrate or stop working. The H-bridge driving circuit 422 is further configured to control the motor 30 to vibrate back and forth in two opposite directions according to the frequency information and vibration amplitude information in the amplified driving signals. The vibration frequency of the motor 30 corresponds to the frequency information in the amplified driving signals, and the vibration amplitude of the motor 30 corresponds to the vibration amplitude information contained in the amplified driving signals.

As shown in FIG. 23, in some embodiments, the H-bridge driving circuit 422 and the PWM output circuit 421 are integrated in the processor 41. That is, the motor driving chip 42 is integrated into the processor 41. In this way, the motor driving chip 42 and the processor 41 are highly integrated, and a creepage distance between the processor 41 and the motor drive chip 42 is short, which realizes short-distance transmission of the driving signals and reduces external electromagnetic interference.

As shown in FIG. 23, in some embodiments, the H-bridge driving circuit 422 is an independent device. In this way, a position of the H-bridge driving circuit 422 is flexibly disposed, and the H-bridge driving circuit 422 and the motor 30 are flexibly connected. For example, the H-bridge driving circuit 422 may be closer to the motor 30, so as to send the amplified driving signals to the motor 30 over a short distance. In addition, the H-bridge driving circuit 422, the PWM output circuit 421 and the processor 41 generate heat when working, especially the H-bridge driving circuit 422 may generate more heat due to frequent switching. The H-bridge driving circuit 422 is kept away from the processor 41 and the PWM output circuit 421 to reduce the heat transfer therebetween and facilitate independent heat dissipation of the H-bridge driving circuit 42.

In addition, the PWM output circuit 421 is integrated in the processor 41, so that the PWM output circuit 421 and the processor 41 are highly integrated, and a creepage distance between the processor 41 and the PWM output circuit 421 is relatively short, which realizes short-distance transmission of the driving signals and reduces the external electromagnetic interference. The PWM output circuit 421 is electrically connected to the motor 30 through the H-bridge driving circuit 422. That is, the PWM output circuit 421 is configured to generate and output the driving signals in the format of the PWM signals. The driving signal is transmitted to the H-bridge driving circuit 422 for amplification, so that the H-bridge driving circuit 422 drives the motor 30 to vibrate.

In some embodiments, the H-bridge driving circuit 422 comprises a metal-oxide-semiconductor (MOS) transistor, and the driving signal is amplified by the MOS transistor. In this way, the power amplification factor of the driving signal by the H-bridge driving circuit 422 is more accurately controlled to more accurately control the vibrations of the motor 30. The audio power amplifier chip generally comprises an analog front end and a digital signal processor (DSP). The analog front end is configured to receive an analog audio signal from an input device, and amplifies and processes signals through an operational amplifier to convert the analog audio signal into a digital signal. The digital signal processor processes the digital signal, and a processing process comprises filtering, equalization, reverberation, equalizer, etc. The audio power amplifier chip pays more attention to restoring an original analog audio signal to improve the fidelity and reduce a distortion rate to improve playback sound quality.

As shown in FIG. 25, in some embodiments, the audio files of the oral care device 1900 are relatively fixed, and the audio files are not updated. The oral care device 1900 may not comprise the communication module 60. At this time, the oral care device 1900 further comprises a battery 20, the storage module 43, and a low dropout linear (LDO) regulator 80. The storage module 43 is electrically connected to the processor 41 and is configured to store the audio files that are fixed. For example, the storage module 43 stores audio files corresponding to fixed reminding sounds and fixed mode sounds. The battery 20 is electrically connected to the motor driving chip 42 (specifically, connected to the H-bridge driving circuit 422), so the battery 20 provides power to the motor driving chip 42. The low dropout linear regulator 80 is electrically connected to the battery 20 and the processor 41. The battery 20 is enabled to stably power the processor 41 through the low dropout linear regulator 80. Through the low dropout linear regulator 80, a working time of the battery 20 is prolonged and the noise is reduced. A model of the low dropout linear regulator 80 may be ME6211C33M5G-N.

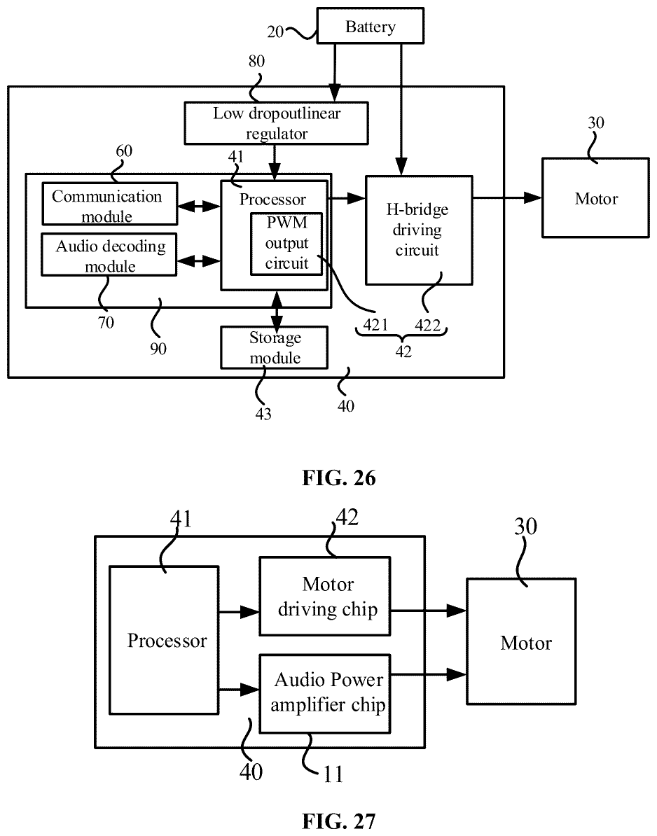

As shown in FIG. 26, in some embodiments, the processor 41 is integrated on a system-level chip 90. Further, different from the oral care device 1900 having the fixed audio files, the system-level chip 90 is integrated with the communication module 60 and the audio decoding module 70. The processor 41 is allowed to receive the target audio file sent by the external terminal through the communication module 60, and the processor 41 decodes the target audio file sent by the external terminal through the audio decoding module 70 to generate the target audio signal.

It is understandable that the processor 41 is able to control the audio decoding module 70 to decode the target audio file received from the external terminal in real time. Alternatively, after receiving the target audio file, the processor 41 is able to store the target audio file in the storage module 43. When the sound needs to be output, the processor 41 calls the target audio file in the storage module 43 and controls the audio decoding module 70 to decode the target audio file to generate the target audio signal. In this way, the user is able to update the sound emitted by the oral care device 1900 as needed to realize customized sound playback.

In some embodiments, the cleaning signal is within a first frequency range. For instance, the first frequency range is 200 Hz-19000 Hz. In this way, the frequency corresponding to the cleaning signal is relatively high, and the motor 30 and the brush head 50 are driven to vibrate at a high frequency, thereby achieving a better teeth cleaning effect. The audio signal is within a second frequency range. For instance, the second frequency range is 20 Hz-20000 Hz. That is, the second frequency range is the frequency range of sounds that can be heard by the human ears. By comparison, it is noted that the first frequency range falls within the second frequency range. That is, the first frequency range partially overlaps with the second frequency range, and thus, it is equivalent to selecting the first frequency range within the second frequency range, that is, selecting the frequency range of the cleaning signal within the frequency range of the sound. Therefore, when the motor 30 is driven by the cleaning signal and the audio signal at the same time, the motor 30 is enabled to have a higher vibration frequency while ensuring that the user can hear the sound, thereby achieving a better teeth cleaning effect.

Optionally, the second frequency range completely overlaps with the first frequency range, and the first frequency range is 200 Hz-19000 Hz, to ensure a better teeth cleaning effect. That is, the frequency range of the audio signal is 200 Hz-19000 Hz. In this way, after the cleaning signal and the audio signal are modulated into a space vector pulse width modulation signal, the frequency range of the space vector pulse width modulation signal is also roughly 200 Hz-19000 Hz. When the motor 30 is driven to move by the space vector pulse width modulation signal, the cleaning motion and sound generation of the oral care device are realized simultaneously. Further, because the motor 30 vibrates within the frequency range of 200 Hz-19000 Hz, the oral care device has a better teeth cleaning effect.

As shown in FIG. 27, in some embodiments, the oral care device 1900 further comprises the audio power amplifier chip 11, or the audio power amplifier chip 11 may directly replace the motor driving chip 42. The audio power amplifier chip 11 is electrically connected to the processor 41 and the motor 30. The processor 41 is configured to send the driving signal to the audio power amplifier chip 11. The driving signal comprises at least one of the cleaning signal and the audio signal. The audio power amplifier chip 11 comprises an operational amplifier configured to amplify the driving signal, so that the amplified driving signal is able to drive the motor 30 to vibrate. When the driving signal comprises the audio signal, the driving signal drives the motor 30 to vibrate regularly and transmits the sound through the medium. The motor 30 is controlled by the amplified audio signal to output the sound with tone and rhythm.

For instance, when there is no need to brush the teeth by the brush head 50, and the regular vibrations and sound generation through the motor 30 is required, the audio signal sent by the processor 41 is amplified by the audio power amplifier chip 11, so that the amplified audio signal has higher fidelity and lower distortion, thereby improving the sound quality when the motor 30 vibrates regularly and generates the sound through the medium.

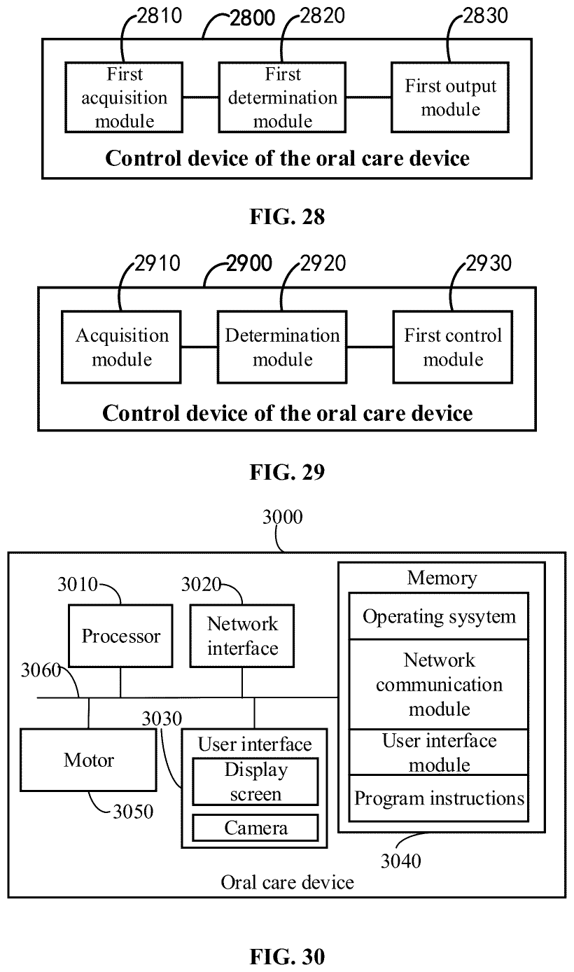

FIG. 28 is a structural schematic diagram of a control device of the oral care device according to one embodiment of the present disclosure. The oral care device comprises a motor. As shown in FIG. 28. the control device 2800 of the oral care device comprises a first acquisition module 2810, a first determination module 2820; and a first output module 2830. The first acquisition module 2810 is configured to obtain target oral care information. The first determination module 2820 is configured to determine a target audio driving signal and a target cleaning driving signal based on the target oral care information and a target driving signal based on the current oral care information. The first output module 2830 is configured to output the target audio driving signal and the target cleaning driving signal to the motor according to a predetermined rule at different time periods, so that the motor is controlled to vibrate based on the target audio driving signal and the target cleaning driving signal. The target audio driving signal and the target cleaning driving signal are output in non-overlapping time periods,

In one optional embodiment, the first output module 2830 is specifically configured to alternately output the target audio driving signal and the target cleaning driving signal to the motor.

In one optional embodiment, the first output module 2830 is specifically configured to: output the target cleaning driving signal to the motor for a first duration, suspend an output of the target cleaning driving signal, output the target audio driving signal to the motor for a second duration, and suspend an output of the target audio driving signal. The circle operation is repeated until oral care work of the oral care device is finished, and then the first output module 2830 is configured to stop outputting the target cleaning driving signal and the output of the target audio driving signal.

In one optional embodiment, the first duration of the target cleaning driving signal is greater than the second duration of the target audio driving signal,

In one optional embodiment, a time interval between the non-overlapping time periods of the target audio driving signal and the target cleaning driving signal is not greater than a target duration.

In one optional embodiment, when the oral care device outputs a cleaning driving signal to the motor, if the target oral care information meets a predetermined condition, the first output module 2830 is configured to suspend an output of the cleaning driving signal and output the target audio driving signal corresponding to the target oral care information to the motor.

In one optional embodiment, when the oral care device outputs an audio driving signal to the motor, if the target oral care information does not meet the predetermined condition or the audio driving signal is completely output, the first output module 2830 is configured to suspend an output of the audio driving signal, and output the target clean driving signal corresponding to the target oral care information to the motor.

In one optional embodiment, when the target oral care information is oral care abnormality or oral care being unable to reach the standard, the target oral care information meets the predetermined condition.

In one optional embodiment, the target oral care information comprises the target oral care pressure currently corresponding to the oral care device, and the predetermined condition comprises that the target oral care pressure is greater than the predetermined pressure; and/or, the target oral care information comprises the target oral care amplitude currently corresponding to the oral care device, and the predetermined condition comprises that the target oral care amplitude is greater than the predetermined amplitude; and/or the target oral care information comprises the current oral care duration corresponding to the current oral care position of the oral care device, and the predetermined condition comprises that the current oral care duration is less than a first predetermined duration.

In one optional embodiment, when the target oral care information meets the predetermined condition, a first target vibration force corresponding to the target audio driving signal is less than a second target vibration force corresponding to the target cleaning driving signal; and/or a first target swing amplitude corresponding to the target audio driving signal is less than a second target swing amplitude corresponding to the target cleaning driving signal; and/or a first target duty cycle corresponding to the target audio driving signal is less than a second target duty cycle corresponding to the target cleaning driving signal.

In one optional embodiment, the target oral care information comprises the target oral care duration currently corresponding to the oral care device, and the predetermined condition comprises the target oral care time reaching a second predetermined duration.

In one optional embodiment, when the target oral care information meets the predetermined condition, a target audio driving amplitude corresponding to the target audio driving signal is reduced, or a target audio driving frequency corresponding to the target audio driving signal is different from a target cleaning driving frequency corresponding to the target cleaning driving signal.

In one optional embodiment, when the target oral care information meets the predetermined condition, the output duration of the target audio driving signal is a fixed duration. Alternatively, the output duration of the target audio driving signal corresponds to a target oral care area currently corresponding to the oral care device.

In one optional embodiment, the target oral care information comprises a current oral care result of the oral care device, and the current oral care result is configured to represent a current oral care attainment of the oral care device.

The control device 2800 of the oral care device further comprises a second output module. When the oral care device stops outputting the cleaning driving signal to the motor, the second output module is configured to output the target audio driving signal corresponding to the target oral care information to the motor based on the target oral care information, so as to control the motor to vibrate based on the target audio driving signal.

In one optional embodiment, the target oral care information comprises a current oral care duration corresponding to a current oral care position of the oral care device.

The control device 2800 of the oral care device further comprises a third output module. When the current oral care duration reaches the first predetermined duration, the third output module is configured to a first audio driving signal is output to the motor.

In one optional embodiment, the first audio driving signal is configured to prompt the care of the current oral care position reaches the standard.

In one optional embodiment, the target oral care information comprises a current oral care progress corresponding to the oral care device.

The control device 2800 of the oral care device further comprises a second determination module and a fourth output module. The second determination module is configured to output a second audio driving signal determined based on the current oral care progress; and the fourth output module is configured to output the second audio driving signal to the motor. When a range of the current oral care progress changes, the second audio driving signal changes.

In one optional embodiment, the number of frequencies corresponding to the target cleaning driving signal is less than the number of frequencies corresponding to the target audio driving signal, and/or the target cleaning driving amplitude of the target cleaning driving signal is greater than the target audio driving amplitude of the target audio driving signal.

In one optional embodiment, the control device 2800 of the oral care device further comprises a second acquisition module and a control module. The second acquisition module is configured to obtain a target audio adjustment instruction when the oral care device outputs the target audio driving signal to the motor. The control module is configured to control target output frequencies of the target audio driving signal, in response to the target audio adjustment instruction, to adjust a tone of a target audio corresponding to the target audio driving signal, and/or the control module is configured to control a continuous output duration corresponding to each of the target output frequencies of the target audio driving signal, so as to adjust a rhythm of the target audio corresponding to the target audio driving signal.

In one optional embodiment, the target oral care information comprises a target oral care pressure currently corresponding to the oral care device. When the target oral care pressure is greater than 0, the first output module 2830 is configured to output the target audio driving signal and the target cleaning driving signal to the motor in different time periods.

In one optional embodiment, the control device 2800 of the oral care device further comprises a fifth output module. When the target oral care pressure is 0, the fifth output module is configured to output the target cleaning driving signal to the motor, or suspend the output of the target cleaning driving signal and the target audio driving signal.

In one optional embodiment, the oral care device also comprises a motor driving piece. The first output module is further configured to output the target audio driving signal and the target cleaning driving signal to the motor in different time periods based on the same phase or different phases of the motor driving piece.

In one optional embodiment, when the motor driving piece outputs the target audio driving signal to the motor, the motor driving piece amplifies the target vibration amplitude corresponding to the target audio driving signal to a predetermined vibration multiple.

In one optional embodiment, the oral care device also comprises the motor driving piece. The target audio driving signal and the target cleaning driving signal are output by the motor driving piece.

In one optional embodiment, the oral care device further comprises a care component. A volume of the sound generated by the motor driven by the target audio driving signal is less than a target volume. The sound generated by the motor is transmitted to the ears of the user currently using the oral care device by bone conduction based on the care component.

In one optional embodiment, the target cleaning driving signal is a target cleaning square wave.

The arrangement of modules in the control device of the oral care device is only for illustrative purposes. In other embodiments, the control device of the oral care device may be divided into different modules as needed to complete all or part of the functions of the control device of the oral care device. Each of the modules in the control device of the oral care device provided in the embodiments of the specification may be a computer program. The computer program may be run on an external terminal or the oral care device. Each of the modules constituted by the computer program may be stored in the memory of the external terminal or the oral care device. When the computer program is executed by a processor, all or part of the steps of the control method of the oral care dev10ice described in the embodiments of the specification are implemented.

FIG. 29 is a structural schematic diagram of a control device of the oral care device according to another embodiment of the present disclosure. As shown in FIG. 29, the oral care device comprises a motor and a care component. The control device 2900 of the oral care device comprises an acquisition module 2910, a determination module 2920, and a first control module 2930. The acquisition module 2910 is configured to obtain current oral care information of the oral care device. The determination module 2920 is configured to determine a target driving signal based on the current oral care information. The first control module 2930 is configured to control the motor of the oral care device to vibrate based on the target driving signal, so that the motor drives the care component of the oral care device to vibrate to generate sound prompting information. The sound prompting information is matched with the current oral care information.

In one optional embodiment, the first control module 2930 is configured to control the motor to drive the care component to asynchronously perform cleaning vibrations and audio vibrations matched with the current oral care information based on the target driving signal, so that the care component performs oral care based on the cleaning vibrations and generates the sound prompting information based on the audio vibrations.

In one optional embodiment, the current oral care information comprises at least one of oral care positions, oral care duration, oral care forces, and oral care amplitudes of oral care information. The cleaning vibrations and the audio vibrations of the care component change with a change of the same oral care information in the current oral care information.

In one optional embodiment, the target driving signal is an area changing reminding signal. The sound prompting information is area changing reminding information. An output duration of the area changing reminding signal is less than a target duration.

In one optional embodiment, the current oral care information comprises a current oral care duration corresponding to a current oral care position of the oral care device, or the oral care information comprises the current oral care duration, and when the current oral care duration reaches a first predetermined duration, the target driving signal is the area changing reminding signal.

In one optional embodiment, the current oral care information comprises a current oral care pressure and/or a current motion amplitude of the oral care device. When the current oral care pressure is greater than 0 and/or the current motion amplitude is greater than 0 and not greater than a predetermined amplitude, the first control module 2930 is specifically configured to control the motor to vibrate based on the target driving signal, so that the motor drives the care component to vibrate to generate the sound prompting information.

In one optional embodiment, the current oral care information comprises the current oral care pressure and/or the current motion amplitude of the oral care device.

In one optional embodiment, the control device 2900 of the oral care device further comprises a second control module. When the current oral care pressure is 0 and/or the current motion amplitude is greater than the predetermined amplitude, the second control module is configured to suspend an output of the target sound prompting signal corresponding to the sound prompting information in the target driving signal to control the motor to drive the care component to stop generating the vibrations of the sound prompting information, or, the second control module is configured to suspend the output of the target driving signal to control the motor to stop vibration,

In one optional embodiment, the current oral care information comprises at least one of the current oral care pressure of the oral care device and the current motion amplitude of the oral care device. The determination module 2920 comprises a first determination unit and a second determination unit. When the current oral care pressure is 0 and/or the current motion amplitude is greater than the predetermined amplitude, the first determination unit is configured to determine a first target driving signal based on the current oral care information. When the current oral care pressure is greater than 0 and/or the current motion amplitude is not greater than the predetermined amplitude, the second determination unit is configured to determine a second target driving signal based on the current oral care information.

In one optional embodiment, the first control module 2930 comprises a first control unit and a second control unit. When the current oral care pressure is 0 and/or the current motion amplitude is greater than the predetermined amplitude, in response to the current oral care information meeting a predetermined condition, the first control unit is configured to control the motor to drive the care component to vibrate to generate the sound prompting information based on the first target driving signal. When the current oral care pressure is greater than 0 and/or the current motion amplitude is not greater than the predetermined amplitude, in response to the current oral care information meeting the predetermined condition, the second control unit is configured to control the motor to drive the care component to vibrate to generate the sound prompting information based on the second target driving signal. A duty ratio of the first target driving signal is greater than a duty ratio of the second target driving signal, and/or a frequency of the first target driving signal is greater than a frequency of the second target driving signal.

In one optional embodiment, when the current oral care information meets a predetermined condition, the first control module 2930 is configured to control the motor to drive the care component to vibrate to generate the sound prompting information based on the target driving signal.

In one optional embodiment, the current oral care information comprises a current oral care total duration of the oral care device. The predetermined condition comprises that the current oral care total duration reaches a predetermined total duration, and the sound prompting information is current oral care up-to-standard prompting information, or the predetermined condition comprises that the current oral care total duration does not reach the predetermined total duration, and the sound prompting information is current oral care non-standard prompting information.

In one optional embodiment, the current oral care information comprises a current oral care duration corresponding to a current oral care position of the oral care device. The predetermined condition comprises that the current oral care duration reaches a second predetermined duration, and the sound prompting information is current oral care position up-to-standard prompting information or an area changing reminding information. Alternatively, the predetermined condition comprises that the current oral care duration does not reach the second predetermined duration, and the sound prompting information is current oral care position non-standard prompting information.

In one optional embodiment, the current oral care information comprises the current oral care pressure of the oral care device. When the current oral care pressure or a pressure range of the current oral care pressure changes, the sound prompting information changes.

In one optional embodiment, the current oral care information comprises the current oral care pressure of the oral care device. The determination module 2920 comprises a third determination unit and a fourth determination unit. When the current oral care pressure is not greater than a first predetermined pressure, the third determination unit is configured to determine a third target driving signal based on the current oral care information. When the current oral care pressure is greater than the first predetermined pressure, the fourth determination unit is configured to determine a fourth target driving signal based on the current oral care information. The first control module 2930 comprises a third control unit and a fourth control unit. When the current oral care pressure is not greater than the first predetermined pressure, the third control unit is configured to control the motor to drive the care component to vibrate at a first vibration amplitude based on the third target driving signal to generate the sound prompting information. When the current oral care pressure is greater than the first predetermined pressure, the fourth control unit is configured to control the motor to drive the care component 50 to vibrate at a second vibration amplitude based on the fourth target driving signal to generate the sound prompting information. A duty ratio of the third target driving signal is greater than a duty ratio of the fourth target driving signal, and the first vibration amplitude is greater than the second vibration amplitude.

In one optional embodiment, the current oral care information comprises the current oral care pressure of the oral care device. The determination module 2920 comprises a fifth determination unit and a sixth determination unit. When the current oral care pressure is not greater than the second predetermined pressure, the fifth determination unit is configured to determine a fifth target driving signal based on the current oral care information. When the current oral care pressure is greater than the second predetermined pressure, the sixth determination unit is configured to determine a sixth target driving signal based on the current oral care information. The first control module 2930 comprises a fifth control unit and a sixth control unit. When the current oral care pressure is not greater than the second predetermined pressure, the fifth control unit is configured to control the motor to drive the care component to vibrate at a third vibration amplitude based on the fifth target driving signal to generate the sound prompting information. When the current oral care pressure is greater than the second predetermined pressure, the sixth control unit is configured to control the motor to drive the care component to vibrate at a fourth vibration amplitude based on the sixth target driving signal to generate the sound prompting information. A duty ratio of the sixth target driving signal is greater than a duty ratio of the fifth target driving signal, and the fourth vibration amplitude is greater than the third vibration amplitude.

In one optional embodiment, the target driving signal comprises a target sound driving signal and a target cleaning driving signal. The control device 2900 of the oral care device further comprises a third control module. When the current oral care pressure is greater than the second predetermined pressure, the third control module is configured to increase an output amplitude of the target sound driving signal, control the motor to increase a vibration amplitude of an audio vibration for driving the care component to generate the sound prompting information based on the target sound driving signal, and reduce an output amplitude of the target cleaning driving signal to control the motor to reduce a vibration amplitude of the cleaning vibrations for driving the care component to perform oral care based on the target cleaning driving signal.

In one optional embodiment, the current oral care information comprises the current oral care pressure of the oral care device. When the current oral care pressure is within a first predetermined pressure range, a duty ratio of the target driving signal decreases as the current oral care pressure increases. When the current oral care pressure is within a second predetermined pressure range, the duty ratio of the target driving signal increases as the current oral care pressure increases. A pressure value of the second predetermined pressure range is greater than a pressure value of the first predetermined pressure.

In one optional embodiment, the current oral care information comprises the current oral care position of the oral care device. When the current oral care position or an attribute of the current oral care position changes, a duty ratio of the target driving signal changes, and a vibration amplitude of sound prompting vibrations generated by the care component driven by the motor changes.

In one optional embodiment, when the current oral care position is an incisor area, the target driving signal is a seventh target driving signal. When the current oral care position is a molar area, the target driving signal is an eighth target driving signal. A duty ratio of the seventh target driving signal is greater than a duty ratio of the eighth target driving signal. An, incisor sound loudness generated by the care component driven by the motor, based on the seventh target driving signal is controlled to be greater than a molar sound loudness, generated by the care component driven by the motor, based on the eighth target driving signal.

In one optional embodiment, the sound prompting information comprises oral care guidance information. The control device 2900 of the oral care device further comprises a fourth control module. When the current oral care information of the oral care device is not matched with the oral care guide information, The fourth control module is configured to control the motor to vibrate based on the target driving signal, so that the motor drives the care component to vibrate to generate target prompting information. The target prompting information comprises target voice prompting information and/or target vibration prompting information.

In one optional embodiment, the oral care guidance information comprises an oral care position currently performing oral care and/or a next oral care position to be switched. The oral care guidance information is determined based on predetermined oral care paths corresponding to oral care positions and the current oral care information.

In one optional embodiment, the control device 2900 of the oral care device further comprises a fifth control module. When a duration for which the current oral care information of the oral care device does not match the oral care guidance information reaches a third predetermined duration, the fifth control module is configured to update the oral care guidance information corresponding to the oral care device based on the current oral care information of the oral care device, and control the motor to drive the care component to vibrate to generate updated oral care guidance information.

In one optional embodiment, the current oral care information comprises the current oral care position of the oral care device. The sound prompting information comprises at least one of an oral care technique corresponding to the current oral care position, an oral care posture, an oral care angle, an oral care amplitude. When the current oral care position changes, the sound prompting information changes.

FIG. 30 is a structural schematic diagram of the oral care device according to another embodiment of the present disclosure. As shown in FIG. 30, the oral care device 3000 may comprise at least one processor 3010, a network interface 3020, a user interface 3030, a memory 3040, a motor 3050, and at least one communication bus 3060.

The at least one communication bus 3060 is configured to realize connection and communication between the various components of the oral care device.

Optionally, the network interface 3050 comprises a BLUETOOTH module, a near field communication (NFC) module, a wireless fidelity (Wi-Fi) module, etc.

The user interface 3030 comprises a display screen. Optionally, the user interface 3030 may further comprise a standard wired interface and a wireless interface.

The motor 3050 is configured to vibrate based on the target audio driving signal and the target cleaning driving signal.

The at least one processor 3010 comprises one or more processing cores. The at least one processor 3010 uses various interfaces and lines to connect various parts of the oral care device 3000. The processor 3010 executes various functions and processes data of the oral care device 900 by running or executing instructions, programs, code sets or instruction sets stored in the memory 940, and calling data stored in the memory 3040. Optionally, the at least one processor 3010 is implemented by at least one hardware of a digital signal processing (DSP), a field programmable gate array (FPGA), and a programmable logic array (PLA). The at least one processor 910 may integrate one or a combination of a central processing unit (CPU), a graphics processing unit (GPU), and a modem. The CPU mainly processes an operating system and an application for the oral care device 900. The GPU is responsible for rendering and drawing content to be displayed on the display screen. The modem is configured to process wireless communications. It is understood that the modem may not be integrated into the at least one processor 3010, but implemented by a chip.

The memory 3040 may be a random access memory (RAM) or a read-only memory (ROM). Optionally, the memory 3040 may be a non-transitory computer-readable medium. The memory 3040 is configured to store the instructions, the programs, the codes, the code sets or the instruction sets. The memory 3040 comprises a program storage area and a data storage area. The program storage area stores the instructions for implementing the operating system, the instructions for at least one function (such as a receiving function, a control function, a determination function, etc.), the instructions for implementing the controls method of the present disclosure, etc. The data storage area stores data involved in the control method of the present disclosure, etc. Optionally, the memory 3040 may be at least one storage device located away from the at least one processor 3010. As shown in FIG. 30, the memory 3040 served as a computer storage medium may comprise the operating system, a network communication module, a user interface module, and program instructions.

In some optional embodiments, the at least one processor 3010 may be configured to call program instructions stored in the memory 3040 and execute any step in any embodiment of the control method.

The embodiments of the present disclosure further provide a computer-readable storage medium, and the instructions are stored in the computer computer-readable medium. When the instructions are executed on a computer or the at least one processor, the computer or the at least one processor executes one or more steps of the control method in any of the embodiments. When component modules of the control device of the oral care device are implemented in a form of software functional units and are sold or used as an independent product, the component modules are stored in the computer-readable storage medium.

In the above embodiments, the present disclosure may be implemented in whole or in part by software, hardware, firmware or any combination thereof. When implemented by software, the software is implemented in whole or in part in a form of a computer program product. The computer program product comprises one or more computer instructions. When the one or more computer program instructions are loaded and executed on the computer, the process or function described in the embodiments of the present disclosure is generated in whole or in part. The computer may be a general-purpose computer, a special-purpose computer, a computer network, or other programmable device. The one or more computer instructions may be stored in the computer-readable storage medium or transmitted through the computer-readable storage medium. The one or more computer instructions may be transmitted from a website site, a computer, a server, or a data center to another website site, another computer, another server or another data center by wired (e.g., coaxial cable, optical fiber, digital subscriber line) or wireless (e.g., infrared, wireless, microwave, etc.) mode. The computer-readable storage medium may be any available medium that is able to be accessed by the computer or a data storage device such as the server or the data center that comprises one or more available media integrated. The one or more available media may be a magnetic medium (e.g., a floppy disk, a hard disk, a magnetic tape), an optical medium (e.g., a digital versatile disc (DVD)), or a semiconductor medium (e.g.,, a solid state disk (SSD)).

Those skilled in the art can understand that all or part of the processes in the above-mentioned embodiments can be implemented by instructing the relevant hardware through the computer programs, and the computer programs may be stored in the computer-readable storage medium. When the computer programs are executed, the processes of the embodiments of the present disclosure are executed. The storage medium comprises the ROM, the RAM, a magnetic disk, an optical disk, or other media that are able to store the program codes. In the absence of conflict, the technical features in the embodiments and implementation schemes of the present disclosure can be combined arbitrarily.

What is claimed is:

1. A control method of an oral care device, comprising steps:
obtaining target oral care information, wherein the target oral care information comprises current oral care information of the oral care device; and
determining a target driving signal based on the current oral care information, and controlling a motor of the oral care device to vibrate based on the target driving signal, so that the motor drives a care component of the oral care device to vibrate to generate sound prompting information.

2. The control method according to claim 1, wherein the step of controlling the motor of the oral care device to vibrate based on the target driving signal, so that the motor drives the care component of the oral care device to vibrate to generate the sound prompting information comprises:
controlling the motor to drive the care component to asynchronously perform cleaning vibrations and audio vibrations matched with the current oral care information based on the target driving signal, so that the care component performs oral care based on the cleaning vibrations and generates the sound prompting information based on the audio vibrations.

3. The control method according to claim 2, wherein the current oral care information comprises oral care information, and the oral care information comprises at least one of oral care positions, oral care duration, oral care forces, and oral care amplitudes;
wherein the cleaning vibrations and the audio vibrations of the care component change with a change of any one of oral care information in the current oral care information.

4. The control method according to claim 1, wherein the target driving signal is an area changing reminding signal, the sound prompting information is area changing reminding information, and an output duration of the area changing reminding signal is less than a target duration; and/or
the current oral care information comprises a current oral care duration corresponding to the current oral care position of the oral care device.

5. The control method according to claim 1, wherein the oral care information comprises a current oral care duration, and when the current oral care duration reaches a first predetermined duration, the target driving signal is the area changing reminding signal.

6. The control method according to claim 1, wherein the current oral care information comprises a current oral care pressure;
wherein the step of controlling the motor of the oral care device to vibrate based on the target driving signal, so that the motor drives the care component of the oral care device to vibrate to generate the sound prompting information comprises:
when the current oral care pressure is greater than 0 and/or the current motion amplitude is greater than 0 and not greater than a predetermined amplitude, controlling the motor to vibrate based on the target driving signal, so that the motor drives the care component to vibrate to generate the sound prompting information.

7. The control method according to claim 1, wherein the control method further comprises:
when a current oral care pressure is 0 and/or a current motion amplitude is greater than a predetermined amplitude, suspending an output of a target sound prompting signal in the target driving signal, so as to control the motor to drive the care component to stop vibrating to stop a generation of the sound prompting information, or
when the current oral care pressure is 0 and/or the current motion amplitude is greater than the predetermined amplitude, suspending an output of the target driving signal, and controlling the motor to stop vibrating.

8. The control method according to claim 1, wherein the current oral care information comprises at least one of a current oral care pressure of the oral care device and a current motion amplitude of the oral care device;
wherein the step of determining the target driving signal based on the current oral care information comprises:
when the current oral care pressure is 0 and/or the current motion amplitude is greater than a predetermined amplitude, determining a first target driving signal based on the current oral care information; and
when the current oral care pressure is greater than 0 and/or the current motion amplitude is not greater than the predetermined amplitude, determining a second target driving signal based on the current oral care information;
wherein the step of controlling the motor of the oral care device to vibrate based on the target driving signal, so that the motor drives the care component of the oral care device to vibrate to generate the sound prompting information comprises:
when the current oral care pressure is 0 and/or the current motion amplitude is greater than the predetermined amplitude, in response to the current oral care information meeting a predetermined condition, controlling the motor to drive the care component to vibrate to generate the sound prompting information based on the first target driving signal; and
when the current oral care pressure is greater than 0 and/or the current motion amplitude is not greater than the predetermined amplitude, in response to the current oral care information meeting the predetermined condition, controlling the motor to drive the care component to vibrate to generate the sound prompting information based on the second target driving signal;
wherein a duty ratio of the first target driving signal is greater than a duty ratio of the second target driving signal, and/or a frequency of the first target driving signal is greater than a frequency of the second target driving signal.

9. The control method according to claim 8, wherein the current oral care information comprises a current oral care total duration of the oral care device, the predetermined condition comprises that the current oral care total duration reaches a predetermined total duration, and the sound prompting information is current oral care up-to-standard prompting information; or the predetermined condition comprises that the current oral care total duration does not reach the predetermined total duration, and the sound prompting information is current oral care non-standard prompting information; or
the current oral care information comprises a current oral care duration corresponding to the current oral care position of the oral care device, the predetermined condition comprises that the current oral care duration reaches a second predetermined duration, and the sound prompting information is current oral care position up-to-standard prompting information or an area changing reminding information, or the predetermined condition comprises that the current oral care duration does not reach the second predetermined duration, and the sound prompting information is current oral care position non-standard prompting information.

10. The control method according to claim 1, wherein the current oral care information comprises a current oral care pressure of the oral care device;
wherein the step of determining the target driving signal based on the current oral care information comprises:
when the current oral care pressure is not greater than a first predetermined pressure, determining a third target driving signal based on the current oral care information; and
when the current oral care pressure is greater than the first predetermined pressure, determining a fourth target driving signal based on the current oral care information;
wherein the step of controlling the motor of the oral care device to vibrate based on the target driving signal, so that the motor drives the care component of the oral care device to vibrate to generate the sound prompting information comprises:
when the current oral care pressure is not greater than the first predetermined pressure, controlling the motor to drive the care component to vibrate at a first vibration amplitude based on the third target driving signal to generate the sound prompting information;
when the current oral care pressure is greater than the first predetermined pressure, controlling the motor to drive the care component to vibrate at a second vibration amplitude based on the fourth target driving signal to generate the sound prompting information,
wherein a duty ratio of the third target driving signal is greater than a duty ratio of the fourth target driving signal, and the first vibration amplitude is greater than the second vibration amplitude.

11. The control method according to claim 1, wherein the current oral care information comprises a current oral care pressure of the oral care device;
wherein the step of determining the target driving signal based on the current oral care information comprises:
when the current oral care pressure is not greater than a second predetermined pressure, determining a fifth target driving signal based on the current oral care information; and
when the current oral care pressure is greater than the second predetermined pressure, determining a sixth target driving signal based on the current oral care information;
wherein the step of controlling the motor of the oral care device to vibrate based on the target driving signal, so that the motor drives the care component of the oral care device to vibrate to generate the sound prompting information comprises:
when the current oral care pressure is not greater than the second predetermined pressure, controlling the motor to drive the care component to vibrate at a third vibration amplitude based on the fifth target driving signal to generate the sound prompting information; and
when the current oral care pressure is greater than the second predetermined pressure, controlling the motor to drive the care component to vibrate at a fourth vibration amplitude based on the sixth target driving signal to generate the sound prompting information;
wherein a duty ratio of the sixth target driving signal is greater than a duty ratio of the fifth target driving signal, and the fourth vibration amplitude is greater than the third vibration amplitude.

12. The control method according to claim 1,wherein the sound prompting information is matched with the current oral care information, and when a current oral care position or an attribute of the current oral care position changes, a loudness/volume of sound prompting vibrations generated by the motor driving the care component changes.

13. The control method according to claim 1, wherein the current oral care information comprises a current oral care pressure of the oral care device; when the current oral care pressure is within a first predetermined pressure range, a duty ratio of the target driving signal decreases as the current oral care pressure increases; when the current oral care pressure is within a second predetermined pressure range, the duty ratio of the target driving signal increases as the current oral care pressure increases; wherein a pressure value of the second predetermined pressure range is greater than a pressure value of the first predetermined pressure.

14. The control method according to claim 1, wherein when the current oral care position is an incisor area, the target driving signal is a seventh target driving signal; when the current oral care position is a molar area, the target driving signal is an eighth target driving signal; a duty ratio of the seventh target driving signal is greater than a duty ratio of the eighth target driving signal,
wherein an incisor sound loudness of the care component driven by the motor based on the seventh target driving signal is controlled to be greater than a molar sound loudness of the care component driven by the motor based on the eighth target driving signal.

15. The control method according to claim 1, wherein the sound prompting information comprises oral care guidance information;
wherein after the step of controlling the motor of the oral care device to vibrate based on the target driving signal, so that the motor drives the care component of the oral care device to vibrate to generate the sound prompting information, the control method further comprises:
when the current oral care information of the oral care device is not matched with the oral care guide information, controlling the motor to vibrate based on the target driving signal, so that the motor drives the care component to vibrate to generate target prompting information;
wherein the target prompting information comprises target voice prompting information and/or target vibration prompting information.

16. The control method according to claim 15, wherein the oral care guidance information comprises an oral care position currently performing oral care and/or a next oral care position to be switched, and the oral care guidance information is determined based on predetermined oral care paths corresponding to oral care positions and the current oral care information.

17. The control method according to claim 16, wherein the control method further comprises:
when a duration for which the current oral care information of the oral care device does not match the oral care guidance information reaches a third predetermined duration, updating the oral care guidance information corresponding to the oral care device based on the current oral care information of the oral care device, and controlling the motor to drive the care component to vibrate to generate updated oral care guidance information.

18. The control method according to claim 1, wherein the control method further comprises:
determining a target audio driving signal and a target cleaning driving signal based on the target oral care information, and outputting the target audio driving signal and the target cleaning driving signal to the motor in different time periods according to a predetermined rule, so as to control the motor to vibrate based on the target audio driving signal and the target cleaning driving signal;
wherein an output time period of the target audio driving signal does not overlap an output time period of the target cleaning driving signal.

19. The control method according to claim 18, wherein the step of alternately outputting the target audio driving signal and the target cleaning driving signal to the motor comprises:
repeating a circle operation until oral care work of the oral care device is finished and stop outputting the target cleaning driving signal and the output of the target audio driving signal, wherein the circle operation comprises outputting the target cleaning driving signal to the motor for a first duration, suspending an output of the target cleaning driving signal, and outputting the target audio driving signal to the motor for a second duration.

20. An oral care device, comprising:
a processor; and
a memory;
wherein the memory is configured to store computer programs, the computer programs are configured to be loaded by the processor to execute steps:
obtaining target oral care information, wherein the target oral care information comprises current oral care information of the oral care device; and
determining a target driving signal based on the current oral care information, and controlling a motor of the oral care device to vibrate based on the target driving signal, so that the motor drives a care component of the oral care device to vibrate to generate sound prompting information;
wherein the sound prompting information is matched with the current oral care information, and when a current oral care position or an attribute of the current oral care position changes, a loudness/volume of sound prompting vibrations generated by the motor driving the care component changes.
